(19) United States
(12) Patent Application Publication
(10) Pub. No.: US 2026/0122348 A1
(43) Pub. Date: Apr. 30, 2026

(54) MULTIPLE BUFFERING MODES FOR VIDEO RECORDING DEVICES

(71) Applicant: Axon Enterprise, Inc., Scottsdale, AZ (US)

(72) Inventors: JUHA ALAKARHU, Helsinki (FI); DAVID MESRI, Paradise Valley, AZ (US); MIKKO MUUKKI, Tampere (FI); KARTHIK NARASIMHAN, Westin, FL (US)

(21) Appl. No.: 19/145,464

(22) PCT Filed: Jan. 5, 2024
(86) PCT No.: PCT/US2024/010580

§ 371 Date: Jul. 2, 2025

Related U.S. Application Data
(60) Provisional application No. 63/478,653, filed on Jan. 5, 2023.

(51) Int. Cl. H04N 23/667; H04N 7/18; H04N 23/65

(52) U.S. Cl. CPC H04N 23/667; H04N 7/185; H04N 23/651

(57) ABSTRACT

Examples of systems, apparatuses and methods described herein may perform buffering of video data having different qualities depending on conditions. An example method includes: operating a system in a first buffering mode to buffer video data having a first quality; responsive to a first condition, operating the system in a second buffering mode to buffer video data having a second quality, wherein the second quality is higher than the first quality; and responsive to a second condition, recording video data using the system.

### TECHNICAL FIELD

Examples described herein relate generally to operating a video recording device. The video recording device may be operated in multiple buffering modes to buffer video data in respective multiple video qualities according to conditions, for example.

### BACKGROUND

Recording devices may be used to record an event. Recording devices at the scene of an incident are becoming more ubiquitous due to the development of body-worn cameras, body-worn wireless microphones, smart phones capable of recording video, security cameras, as well as societal pressure that security personnel, such as police officers, carry and use such recording devices.

In addition to a carried or worn recording device, such as a body-worn camera or smartphone, additional recording devices may be present at a scene-such as stationary security cameras, dash cameras in an automobile (such as a police car) at or near the scene.

Existing recording devices, such as body-worn cameras, may be limited in their ability to store data based on a battery life and/or storage capacity of the device.

### BRIEF DESCRIPTION OF THE DRAWINGS

FIG. 1 is a block diagram of an apparatus according to an embodiment of the present disclosure.

FIG. 2 is a state diagram showing modes and transitions between the modes according to an embodiment of the present disclosure.

FIG. 3 is a block diagram of a system including an apparatus according to an embodiment of the present disclosure.

FIG. 4 is a block diagram of storage according to an embodiment of the present disclosure.

FIG. 5 is a block diagram of storage according to an embodiment of the present disclosure.

Video recording devices, such as video cameras including body-worn cameras and/or vehicle-mounted cameras may generally operate in two different modes in which data is recorded. One mode may be a pre-event mode. Another mode may be an event mode. In each mode, image, audio, and/or position data may be continuously captured from a corresponding sensor. The two modes may differ in terms of how this data is stored.

In the pre-event mode, storing data may include buffering data. The data may be buffered in a buffer of the recording device. For example, video data captured via an image sensor of a body-worn camera may be buffered in a buffer of the camera in accordance with the camera operating in the pre-event mode. Buffering the data may include continuously buffering most recently captured video data. Buffering the data may include temporarily storing the data. The data may be temporarily stored in accordance with a predetermined limit associated with captured data. For example, the data may be buffered in the buffer for a predetermined period of time and/or at a predetermined size of buffer. The data may be buffered until either the predetermined time elapses or the predetermined buffer size is full. When the predetermined time elapses since the oldest data in the buffer was captured, or the predetermined buffer size is reached, the oldest data in the buffer may be overwritten with the most recently captured data. The most recently captured video data may be continuously buffered while the recording device is operated in the pre-event mode. In embodiments, buffered data may also be continuously automatically deleted, including by being overwritten or otherwise rendered inaccessible, until the recording device enters an event mode.

In embodiments, while the recording device is operating in a pre-event mode, the recording device may transition to an event mode. For example, the recording device may transition to the event mode responsive to an activation signal. An activation signal may be provided to, or generated by, the recording device. The activation signal may be indicative of an event of interest. Examples of events of interest include an interaction between a police officer and a suspect, an interview of a suspect or other person, an interaction between individuals or groups of people. Other events may occur in other examples. Upon transitioning to the event mode, the recording device may discontinue buffering data.

In the event mode, storing data may include recording data. Data captured while a recording device is operated in the event mode may be recorded in a memory of the recording device. For example, video data captured via an image sensor of a body-worn camera may be recorded in a memory of the camera in accordance with the camera operating in the event mode. Recording the data may include non-temporarily storing the data in the memory. The recorded data may be retrieved or transmitted for review or remote storage. Data captured by the recording device may not be available for review or remote storage unless the data is recorded in the memory of the recording device. The recorded data may be preserved and not overwritten. The recorded data may be retained in memory of the recording device until the recording device is transmitted to remote storage and/or an instruction from an external source to delete the data is received. Accordingly, in the event mode, the data may not be buffered, but may be continuously recorded. There may be no limit, other than physical limitations, as to how much recorded data is stored or how long data is stored for. The stored recorded data may be selectively deleted after a user's data retrieval/transmission operation or deletion operation.

When creating a final collection of video data for review of the event (e.g., one or more evidence or video files), the buffered data may be provided together with the recorded data for an event. In this manner, additional data captured in the milliseconds, seconds, or minutes before the activation signal was received may be included in evidence or video file for an event. By buffering data prior to an activation signal, and including the buffered data together with the recorded data captured after the activation signal, a more complete record of an event may be achieved, because in some cases the activation signal may be delayed past an interesting start of the event—e.g., it may take some time for a user of the video recording device to generate or provide the activation signal.

In embodiments, when a recording device transitions from a pre-event mode to an event mode, buffered data may be further recorded in memory of the recording device. For example, buffered video data in a buffer of a body-worn camera may be further recorded in a memory of the body-worn camera when the body-worn camera enters an event mode from a pre-event mode. Operating the recording device in the event mode may include preserving buffered data that was not automatically deleted while the recording device was operated in the pre-event mode. The buffered data may be preserved in the memory to which it is subsequently recorded, instead of being automatically deleted from one or more buffers in which the buffered data is initially, temporarily stored on the recording device. In some examples, recording the buffered data may comprise copying the buffered data from a buffer to a memory logically separate from the buffer. In other examples, recording the buffered data may comprise marking the buffered data as protected such that it is not subsequently overwritten with more recently captured data. In the latter examples, unmarked buffered data may be subsequently overwritten with more recently captured data. In the latter examples, the buffered data may be preserved in a same storage medium in which the buffered data is initially buffered.

In some examples, the buffered data may be appended to data that is subsequently captured and recorded in accordance with the recording device operating in the event mode. For example, buffered video data that has been temporarily stored in a buffer of a body-worn camera may be appended to recorded video data that is subsequently captured and non-temporarily stored in a memory of the body-worn camera. Accordingly, the final collection of data for an event may include data captured while the recording device is operated in both a pre-event mode and an event mode, thereby providing information representing one or more activities of an event that occurred before and after indication of the event was received by the recording device. Unless data captured for a period of time has not been automatically deleted by a subsequent time at which the recording device transitions from the pre-event mode to the event mode, the data captured for the period of time will be automatically deleted without being recorded. Accordingly, and in embodiments, buffered data is not provided or otherwise available for subsequent review unless the buffered data is preserved with recorded data captured and recorded while the recording device is operated in the event mode. In accordance with such an arrangement operations for capturing and buffering data are chronologically separate from an operation to record this same data.

In the pre-event mode, video processing, such as capturing, encoding, and buffering processes may be operated in the video recording devices, regardless of inactivity or low probability of event occurrence, which may result in undesirable power consumption of the video recording devices. Thus, it may be desirable to reduce power consumption when operating such video recording devices in case of inactivity or low probability of event occurrence.

Various embodiments of the present disclosure will be explained below in detail with reference to the accompanying drawings. The following detailed description refers to the accompanying drawings that show, by way of illustration, specific aspects and embodiments of the disclosure. Other embodiments may be utilized, and structural, logical, and electrical changes may be made without departing from the scope of the present disclosure. The various embodiments disclosed herein are not necessarily mutually exclusive, as some disclosed embodiments can be combined with one or more other disclosed embodiments to form new embodiments. Thus, the following more detailed description of the embodiments of the systems, methods, and apparatuses is not intended to limit the scope of the disclosure, but is merely representative of possible embodiments of the disclosure. In some cases, well-known recording device components, computing system components, materials, or software or other operations are not shown or described in detail.

The present disclosure provides various embodiments of operating an apparatus, such as a video recording device, in multiple buffering modes. The apparatus may operate in the multiple buffering modes sequentially. A pre-event mode of the apparatus may include the multiple buffering modes. Operating the apparatus in the pre-event mode may include automatically operating the apparatus in different buffering modes of the multiple buffering modes responsive to different conditions. Operating the apparatus in the pre-event mode may include automatically operating the apparatus in one buffering mode of the different buffering modes at a time. Operating the apparatus may further comprise automatically operating the apparatus in either the pre-event mode or the event mode at a time. According to various embodiments, a system, such as a portable camera attached to a human body, may be operated in a first buffering mode to buffer video data having a first quality. Responsive to a first condition, the system may be operated in a second buffering mode to buffer video data having a second quality. The system may stop operating in the first buffering mode upon being operated in the second buffering mode. The second quality is generally higher than the first quality. Responsive to a second condition, the system may be operated to record video data. The system may record the video data in accordance with operating in a recording mode, different from the multiple buffering modes of the system. An event mode of the system and/or apparatus may include the recording mode. The system may stop operating in the second buffering mode upon being operated in the recording mode. In some examples, recorded video data may have the second quality. Examples described herein may append at least a portion of the buffered video data (of either or both the first or second quality) to the recorded data. So, a first buffering mode may be a lower power buffering mode which may buffer lower quality video data. A second buffering mode may be entered when there is an increased probably of an event. This second buffering mode may buffer higher quality video data than in the first buffering mode, and may accordingly consume more power. The quality of video recorded in this second buffering mode may be similar or the same level of quality used in an event mode. However, and as discussed above, buffered data temporarily stored in accordance with each of the multiple buffering modes may be overwritten or otherwise deleted unless the recording device further enters the event mode.

In the event mode, data is recorded. The event mode may include a recording mode. Operating a system in the event mode may include operating the system in the recording mode. In the event mode of a system comprising a video recording device, video processing, such as capturing, encoding, and recording processes may be performed by the video recording device in order to preserve information representing an event for subsequent review. Examples described herein may advantageously provide a longer coverage of pre-event activities with less power consumption compared to a system that provides coverage of pre-event activities with only a single buffering mode that utilizes power consumption similar to recording of the event.

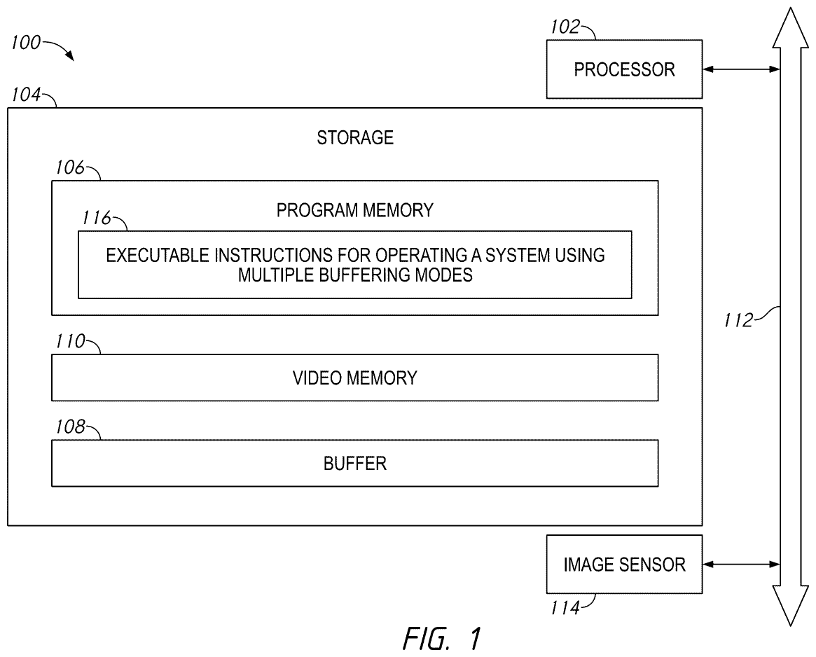

Examples of apparatuses described herein may accordingly include video recording devices. FIG. 1 is a block diagram of an apparatus according to an embodiment of the present disclosure. The apparatus may be a video recording device 100. The recording device 100 may comprise a wearable recording device. The recording device 100 may be configured to be worn by a person. The person may comprise a user of the recording device 100. The recording device 100 may include one or more processors 102, one or more storage devices 104, and one or more image sensors 114. The one or more processors 102 may be in electrical communication with the one or more storage devices 104 and the one or more image sensors 114 as indicated by connection 112. The storage devices 104 of FIG. 1 are depicted as including program memory 106, video memory 110, and buffer 108. The program memory 106 is depicted as including executable instructions for operating a system using multiple buffering modes 116.

The components shown in FIG. 1 are exemplary only. Additional, fewer, and/or different components may be used in other examples. Additionally, the arrangement of storage devices 104 may be quite flexible, and the data and instructions described as being stored in storage devices may be stored together in one storage device or distributed across several storage devices. As another example, recording devices, such as recording device 100 of FIG. 1, may have one or more components for communication-such as one or more wireless or wired communication interfaces for communication using, for example, WI-FI, BLUETOOTH, cellular, or other communication technique.

Examples of apparatuses described herein, such as recording device 100 of FIG. 1, may be video recording devices. Generally, video recording device may include one or more processors which may be used to process video data received from an image sensor. The one or more processors may store the video data in various modes, either by buffering (using multiple buffering modes in some examples) or recording depending on conditions. The one or more processors may further buffer the video data in a higher quality or a lower quality depending on conditions. In some embodiments, the one or more processors, in accordance with the executable instructions for operating using multiple buffering modes, may determine whether a condition for recording the video data, a condition for buffering the video data in a higher quality, or a condition for buffering the video data in a lower quality is met. Based on the determined condition, the one or more processors may store the video data by either recording the video data, buffering the video data in a higher quality or buffering the video data in a lower quality-or more generally, buffering video data in a quality associated with a selected buffering mode of multiple buffering modes, or recording video data.

Example video recording devices may be implemented using one or more body cameras, for example, which may be attached to a human body, in some examples. Other video recording devices which may be used to implement recording device 100 of FIG. 1 may include portable cameras, wearable devices (e.g., smart watches, or ankle-, finger-, or head-worn camera devices) including or in communication with one or more image sensors; portable computers, such as tablets or laptops, including or in communication with one or more image sensors; smart phones including or in communication with one or more image sensors; vehicles including or in communication with one or more image sensors; appliances including or in communication with one or more image sensors, drones including or in communication with one or more image sensors, or smart security systems including or in communication with one or more image sensors. Generally, any system having one or more processor(s); a storage, such as memory; and one or more image sensors may be used to implement video recording devices described herein.

Examples of recording devices described herein, such as recording device 100 of FIG. 1, may include one or more processors, such as one or more processors 102 of FIG. 1. Any number or kind of processing circuitry may be used to implement one or more processors 102 such as, but not limited to, one or more central computing units (CPUs), graphical processing units (GPUs) specialized for high-speed image processing, logic circuitry, field programmable gate arrays (FPGAs), application specific integrated circuits (ASICs), controllers, and/or microcontrollers.

Examples of recording devices described herein may include one or more storage devices, such as storage devices 104 of FIG. 1. While storage device 104 is depicted as, and may be, integral with the recording device 100, in some examples, one or more storage devices, including storage device 104, may be external to the recording device 100 and may be in communication with one or more processors 102 and/or other processors in communication with one or more processors 102. While a single storage device 104 is shown in FIG. 1, generally any number of storage devices may be present and/or used in examples described herein. Examples of storage devices which may be used include one or more memory devices. Examples of memory which may be used include read only memory (ROM), random access memory (RAM), solid state drives, and/or SECURE DIGITAL cards (SD cards).

Any of a variety of software (e.g., executable instructions) and/or data may be stored in storage devices in communication with a recording device described herein. The storage device 104 of FIG. 1 is depicted as including a program memory 106, one or more buffers 108 and a video memory 110. The program memory 106 may be encoded with one or more software programs that include executable instructions to be executed by the one or more processors 102, such as executable instructions. While the program memory 106, the buffer(s) 108, and the video memory 110 are shown schematically distinct in FIG. 1, it is to be understood that software and data may be stored generally distributed across one or more storage devices, such as one or more memories. Accordingly, data and instructions described with one or more of the video memory, buffer(s), and/or program memory may flexibly be stored in any location, together, intermingled, or separately.

Examples of recording devices described herein, such as recording device 100 of FIG. 1 may operate in accordance with software (e.g., executable instructions stored on one or more computer readable media, such as memory, and executed by one or more processors). Examples of software may include executable instructions for operating a system using multiple buffering modes 116 of FIG. 1. For example, the executable instructions for operating a system using multiple buffering modes 116 may provide instructions and/or settings for operating the recording device 100 in a first buffering mode to buffer video data having a first quality, instructions and/or settings for recording video data, and instructions and/or settings for operating the recording device 100 in a second buffering mode to buffer video data having a second quality that is higher than the first quality, responsive to different conditions. In some examples, the recorded video data may have the second quality.

Examples of recording devices described herein may record video data. For example, video data may be recorded in video memory 110 of FIG. 1. Generally, recording video data described herein (in contrast to buffering video data) refers to a process of storing video data, typically following an indication of an event, in a manner that is not intended to be overwritten after a particular period of time or storage limit is reached. In some examples, the video memory 110 may store the recorded video data until a user takes an action to erase the recorded video data. In some examples, the recorded video data may be erased upon reading out the recorded video data, or upon transmission of the recorded video data to another device. In some examples, recording the video data may include storing the video data in non-volatile memory until an instruction to delete the recorded video data is received.

Examples of recording devices described herein may include one or more buffers to store buffered video data, such as the buffers 108 of FIG. 1. The one or more buffers 108 may temporarily store buffered video data. The one or more buffers 108 may include volatile memory in which the video data is temporarily stored. In some examples, the one or more buffers 108 may include one or more ring buffers that have data structures that may allow sequential access as if a tail of each buffer is connected to a head of each buffer. In some embodiments, the executable instructions for operating a system using multiple buffering modes 116 may further cause the recording device 100 to overwrite an area of the one or more buffers 108 that has been previously written. In some examples, the one or more buffers 108 may include at least one buffer in which video data of different qualities may be commonly stored. In this manner, data may be buffered using one or more buffering modes-for example, data may be captured and temporarily stored prior to an indication of an event for more permanent recording. This buffered data may allow for retention of some amount of data prior to the indication of the event occurring, and data recording beginning. In this manner, a more complete record of events may be achieved by combining buffered data with data recorded after the indication of an event or indication that recording should begin.

Examples of recording devices described herein, such as recording device 100 of FIG. 1 may include one or more image sensors, such as one or more image sensors 114 of FIG. 1. While an image sensor 114 is depicted as, and may be, integral with the recording device 100, in some examples, the image sensor 114 may be external to the recording device 100 and may be in communication with one or more processors 102 and/or other processors in communication with one or more processors 102. While a single image sensor 114 is shown in FIG. 1, generally any number of image sensors 114 may be present and/or used in examples described herein. Examples of image sensors 114 which may be used include charge-coupled device (CCD) and active-pixel sensors (CMOS sensor). The one or more image sensors 114 may capture image data and provide video data (e.g., one or more frames of image data) based on the captured image data. In some embodiments, the video data may include raw image data without processing. The raw image data may generally include an array of pixel values representing the scene captured by the image sensor(s) 114. The pixel values may be black and white, RGB, CMYK, or other encoded pixel values that may represent intensity and/or color. In some embodiments, the video data may be further processed using one or more processors 102. In some embodiments, at least a portion of the one or more processors 102 may be included in the one or more image sensors 114.

The executable instructions for operating a system using multiple buffering modes 116 may include executable instructions that cause the one or more processors 102 to operate the one or more image sensors 114 to provide video data having a particular quality level. In some examples, the quality level of the captured image data may vary by mode. In some examples, the executable instructions for operating a system using multiple buffering modes 116 may further include executable instructions that cause the one or more processors 102 to operate the one or more image sensors 114 to provide video data having one quality level in one buffering mode and to provide video data having a different quality level in another buffering mode. Changing a mode of the system may comprise changing a manner in which an image sensor is operated. A same image sensor may be used to provide different video data having different quality levels in accordance with each of the different modes. Any number of buffering modes, and quality levels, may be used. In some examples, the one or more processors 102 may operate the one or more image sensors 114 to provide video data having a quality level for recording the video data (e.g., after an event indicator has been received). In some embodiments, one quality level may have one frame rate (e.g., 15-24 fps), and another quality level may have a second, different frame rate (e.g., 30 fps). In some embodiments, the one quality level may have a particular resolution (e.g., 720p), and another quality level may have a different resolution (e.g., 1080 p, 1440 p, HD, etc.). Operating an apparatus in a given pre-event mode or event mode may comprise instructing, by the one or more processors 102, the one or more image sensors 114 to capture data in accordance with a respective frame rate and/or respective resolution that has been predetermined for the quality level associated with the given mode. Accordingly, quality level may refer to frame rate and/or resolution of the captured and/or buffered or recorded video data. Generally, a higher quality level (e.g., a higher frame rate and/or resolution) may utilize a larger amount of data storage and/or a larger amount of power for a particular time of data capture. By modifying a manner in which video data is captured by a same image sensor in accordance with the mode, resources that might otherwise be expended to convert video data into a different quality level after the video data is captured.

Examples of recording devices described herein may have multiple buffering modes. Generally, one or more buffering modes may be used prior to entering a mode in which data is recorded-e.g., following an indication that an event is occurring, and recording is desirable. In some examples, however, the buffering modes may additionally or instead be used after an event has occurred or an indication to stop recording is provided. In some examples, a recording device, such as recording device 100 of FIG. 1 in accordance with the executable instructions for operating using multiple buffering modes 116 may initially operate in one buffering mode that may buffer video data having a particular quality level. This quality level associated with the initial buffering mode may be a lower quality level than one associated with a subsequent buffering mode. The lower quality level may result in video data having a smaller data size than the data size of the video data representing an identical scene in another buffering mode due to lower quality, such as a lower frame rate or a lower resolution, of the video data in the initial buffering mode. Accordingly, a video processing load in the initial buffering mode may be less than in other modes, which may result in less power consumption by the recording device 100. In same or other examples, the recording device may also transition from one buffering mode that may buffer video data having a higher quality level than one associated with a subsequent buffering mode. Recording device 100 may operate in a first buffering mode and, responsive to an idle condition, transition to a second buffering mode that buffers video data having a lower frame rate and/or a lower resolution relative to video data that is buffered in accordance with the first buffering mode. In embodiments, recording device 100 may automatically transition between different buffering modes, including in a manner that sequentially increases or decreases a quality level of the resulting buffered data. In such embodiments, recording device 100 may automatically transition between different buffering modes, including between modes in which higher and lower quality video data are alternately buffered, independent of recording device 100 being operated in an event mode in which video data is recorded. For example, recording device 100 may operate in a first buffering mode, transition to a second buffering mode, and then further transition back to the first buffering mode without transitioning to an event mode. Recording device 100 may automatically transition between the multiple buffering modes before and/or after operating in an event mode. Recording device 100 may automatically modify a quality at which captured video data is buffered before and/or after recording video data in an event mode. The quality may be automatically modified in accordance with the recording device 100 operating in multiple, different buffering modes.

Examples of recording devices described herein may utilize multiple buffering modes to save power and/or storage space in some examples. Recording devices described herein, such as recording device 100 of FIG. 1 operating in accordance with executable instructions for operating a system using multiple buffering modes 116, may transition between multiple buffering modes before and/or after recording of an event. Initial buffering mode(s) may utilize a lower quality level of buffered video data, but as conditions indicate that an event (e.g., a request to begin recording) is more likely, another buffering mode may be used which buffers a higher quality level of video data. Alternately or additionally, an initial buffering mode(s) may utilize a higher quality level of buffered video data, but as conditions indicate that an event (e.g., a request to begin recording) is less likely, another buffering mode may be used which buffers a lower quality level of video data.

Using multiple buffering modes, a recording device, such as the recording device 100, may buffer pre-event video data with increasing and/or decreasing levels of quality, depending on the probability of an event of interest. Once an event is indicated, the recording device begins recording data for the event, the recording may be performed at a particular quality level for the recording. The buffered data (which generally may have been captured before a request to begin recording was received) may be appended onto the recorded data to provide a more complete record of the event. By utilizing multiple buffering modes, power and/or storage space may be saved, particularly during times when the likelihood of an event occurring is low.

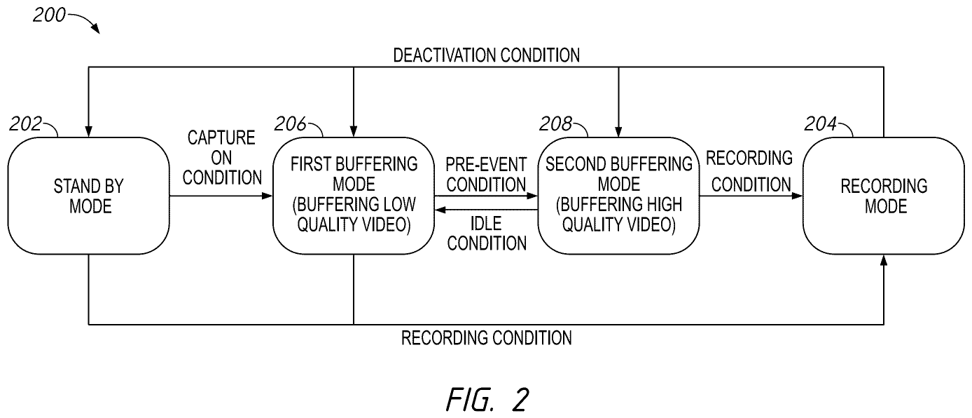

FIG. 2 is a diagram 200 showing modes of operation and transitions between the modes of operation for a recording device according to an embodiment of the present disclosure. The diagram 200 illustrates a standby mode 202, multiple buffering modes, and a recording mode 204. The multiple buffering modes include a first buffering mode 206 and a second buffering mode 208. In embodiments, an event mode of the recording device may include the recording mode 204. Alternately or additionally, a pre-event mode of the recording device may include the multiple buffering modes, including the first buffering mode 206 and/or the second buffering mode 208.

In embodiments, the recording device may transition between the different modes responsive to various conditions. For example, a capture on condition may cause a transition from standby mode 202 to first buffering mode 206. A pre-event condition may cause a transition to a second buffering mode 208, which may generally buffer video data at a higher quality level than first buffering mode 206. An idle condition may cause a transition from the second buffering mode 208 back to the first buffering mode 206. A recording condition may cause a transition from the second buffering mode 208 to a recording mode 204. A deactivation condition may cause a transition from the recording mode 204, the second buffering mode 208, and/or the first buffering mode 206 to a standby mode 202. A recording condition may also cause a transition from the standby mode 202 and/or the first buffering mode 206 to the recording mode 204.

The mode diagram 200 depicts modes which may be utilized by recording devices described herein, such as the recording device 100 of FIG. 1. For example, the executable instructions for operating a system using multiple buffering modes 116 may include executable instructions for operating in each of the modes shown in FIG. 2 and for transitioning between the modes and for identifying the conditions which cause the transitions.

The diagram 200 is exemplary only. Additional, fewer, and/or different modes or transitions may be used in other examples. For example, two buffering modes are shown in FIG. 2, but any number may be used. In some embodiments, three or four buffering modes may be used.

Accordingly, recording devices described herein, such as recording device 100 of FIG. 1, may operate in a standby mode, such as standby mode 202 of FIG. 2. In some embodiments, when the recording device is supplied with power, the recording device may be in standby mode. In the standby mode, image capture by the recording device 100 may be prevented. In the standby mode, the one or more processors 102 may cause the one or more image sensors 114 to stop capturing image data and providing video data. In the standby mode, the one or more processors 102 may also stop buffering and/or recording the video data in the buffer 108 and/or the video memory 110. The recording device 100 may be supplied with a standby power voltage in some examples to keep operating standby functionalities in preparation for transitions to the first buffering mode 206, the second buffering mode 208, or to the recording mode 204. In some examples, and in the standby mode, the one or more processors 102 may keep processing non-video information, such as communications, geographical information, movement, etc., to detect the change of conditions that causes the recording device 100 to move to different modes. Because no, or a reduced amount of, operation regarding the video processing is performed in the standby mode 202, the video processing load for recording device 100 may become less, which may result in less power consumption.

In some examples, the executable instructions for operating a system using multiple buffering modes 116 may include executable instructions that cause the recording device 100 to transition to the standby mode 202. In some examples, the recording device 100 may transition from any mode to the standby mode 202 when a deactivation condition for a transition to the standby mode 202 is met. The deactivation condition may include receiving a predetermined input via a user interface of the recording device 100. For example, the recording device 100 may transition from any mode to the standby mode 202 when a user of the recording device 100 deactivates the recording device 100 such as by such as by pressing a button to turn off a power supply of the recording device 100. As another example, the recording device 100 may transition from recording mode 204 to one of first buffering mode 206 or second buffering mode 208 in accordance with a user interface of recording device 100 being actuated to end recording of an event. The deactivation condition may include detecting, by the one or more processors 102, that the button has been pressed to deactivate the recording device 100. In some examples, the recording device 100 may determine that the deactivation condition for the transition to the standby mode 202 is met when the recording device 100 detects that a remaining power in the battery is at or below a predetermined level (e.g., 0%, 10%, etc.).

Examples of recording devices described herein may transition from a standby mode to an initial buffering mode responsive to a capture on condition. The executable instructions for operating a system using multiple buffering modes 116 may include executable instructions that cause the recording device 100 to transition to the initial buffering mode from the standby mode 202 responsive to the capture on condition being detected.

In embodiments, the initial buffering mode may include first buffering mode 206. The recording device 100 may transition from the standby mode 202 to first buffering mode 206 in accordance with the executable instructions 116. The transition from standby mode 202 to first buffering mode 206 may be made when a capture on condition or signal is detected, determined, received and/or indicated. For example, the capture on condition may include a predetermined input being received via a user interface of the recording device 100 to supply power from a power supply of the recording device 100 to one or more components of the recording device 100. The one or more components may include, for example, the one or more image sensors 114.

In some embodiments, when the one or more components of recording device 100 are supplied with power, the recording device 100 may begin operation in the first buffering mode 206. In some embodiments, the first buffering mode 206 may be selected as a default mode. The first buffering mode 206 may have a quality level which is generally lower than that in the second buffering mode 208 and/or recording mode 204. The recording device 100 may buffer video data in the first buffering mode 206 by default upon exiting the standby mode 202 in response to a capture on condition. In other embodiments, the initial buffering mode may include second buffering mode 208, rather than first buffering mode 206. The second buffering mode 208 may have a quality level which is generally higher than that in the first buffering mode 206. In such embodiments, the second buffering mode 208 may be selected as the default mode in which the recording device 100 operates when the recording device 100 is supplied with power and recording device 100 is not operating in an event mode.

Examples of recording devices described herein may transition from one buffering mode to another buffering mode having a higher video quality level based on detection or indication of a pre-event condition. For example, the recording device 100 of FIG. 1 may, in accordance with executable instructions 116, transition from first buffering mode 206 to second buffering mode 208 of FIG. 2, responsive to a pre-event condition. In this manner, when the recording device 100 predicts that there is an increased likelihood that an event will be requested to be recorded, the recording device 100 may transition to second buffering mode 208. The recording device 100 may transition to the second buffering mode 208 from first buffering mode 206 prior to the recording device 100 detecting or receiving an indication of an event. The recording device 100 may buffer video data having a quality level generally higher in the second buffering mode 208 than in the first buffering mode 206. In some examples, the executable instructions for operating a system using multiple buffering modes 116 may further include executable instructions which, when executed by the one or more processors 102, further cause the recording device 100 to identify a pre-event condition that is indicative of an increased probability that a request to record an event will be made. If the recording device 100 transitions to the second buffering mode 208, the recording device 100 may buffer video data in the second quality upon determining or identifying the pre-event condition indicative of the increased probability of an event of interest. However, and including as further discussed here, the video data buffered in the second quality may not be recorded in the recording device 100 unless an additional condition occurs. The recording device 100 may transition to the second buffering mode 208 from first buffering mode 206 independent of whether the recording device 100 subsequently detects or receives an indication of an event. In some embodiments, including as further discussed herein, the recording device 100 may transition back to the first buffering mode 206 from the second buffering mode 208 without operating in the recording mode 204.

In embodiments, a recording device may be able to detect a plurality of pre-event conditions. Detection of one pre-event condition of the plurality of pre-event conditions may cause the recording device 100 to transition from first buffering mode 206 to second buffering mode 208. Each pre-event condition may comprise a logical combination of one or more parameters. In some examples, a same parameter may be employed to logically identify two or more different pre-event conditions of the plurality of pre-event conditions. The one or more processors 102 may be configured, in accordance with instructions 116, to receive indications or detect information for parameter(s) associated with each pre-event condition of the plurality of conditions in parallel. Instructions 116 may store condition information, such as one or more parameter values, by which each of the pre-event conditions may be respectively Indication of one of the pre-event conditions of the plurality of pre-event conditions, as detected or received by recording device 100, may be sufficient to cause a transition between buffering modes.

Examples of pre-event conditions which may cause recording devices described herein to transition from a lower video quality level buffering mode to a higher video quality level buffering mode include conditions which may indicate an increased likelihood of a recording event occurring. While indicating the increased likelihood, each pre-event condition of the examples yet includes a non-activation condition. A pre-event condition may be non-determinative with respect to whether a recording event subsequently occurs. The pre-event condition may merely indicate that a recording event is more likely to occur and, accordingly, the buffering mode may be changed. A pre-event condition is different from a recording condition. For example, a pre-event condition alone may be insufficient to indicate an event. A pre-event condition may not modify a manner in which captured video is stored, aside from a change in a quality level of the captured video being stored. A pre-event condition may cause the recording device to continue buffering data that is automatically deleted in accordance with a predetermined limit or predetermined limits on the temporary storage of pre-event data. Unless a further condition is detected or otherwise is received by a recording device, such as a recording condition involving the receipt of an activation signal, the recording device may not enter a recording mode in which captured data is recorded for an event.

In some examples, the pre-event condition may be based on an attribute of the user of the recording device. Determining the pre-event condition may include determining, by the recording device, the attribute of the user as detected by the recording device. For example, the recording device may detect and/or receive information indicating an activity in which the user is engaged or is likely to engage. Responsive to such information, the recording device may determine the pre-event condition has occurred. In some examples, the recording device 100 may transition to the second buffering mode (e.g., the second buffering mode 208 in FIG. 2) based on the detected pre-event condition.

In some examples, when the user of the recording device is engaged in a certain task, the pre-event condition may be met. The task may include an activity performed, or to be performed, by the user of the recording device. Engagement or association of the user with the task may indicate that an event may subsequently occur for which data may be recorded. The pre-event condition may include receiving and/or detecting an indication by the recording device that the user of the recording device is associated with (e.g., engaged in, assigned to, etc.) with the certain task. The user may be associated with the task in accordance with acceptance of the task by the user as detected by the recording device. The task and/or the association of the task with the user may not be separately detected or detectable by the recording device without the indication. The user of the recording device may not be associated with the task prior to the indication being received and/or detected by the recording device. For example, the recording device 100 may be a body-worn camera used by an officer, and the officer or other user may accept a task by providing an indication of acceptance of the task responsive to a request from a dispatch system. The task may include, for example, responding to a call for service. The recording device may receive the indication of the acceptance of the task in accordance with an input from the officer detected via a user interface of the recording device. Alternately or additionally, an indication that the user has been accepted and/or assigned to a task may be communicated from a remote computing device to the recording device. For example, a computer aided dispatch (CAD) system in communication with the recording device may transmit an indication that the user of the recording device has been assigned to a certain task. In accordance with receiving the indication, the recording device may store information in a memory of the recording device indicating that the certain task has been associated with the user. In some examples, the acceptance of a task may be the pre-event condition that may cause the recording device 100 to transition from a lower power buffering mode to a higher power buffering mode. For example, processor 102 may receive the indication of the acceptance of the task and, responsive to receiving the indication, transition to the second buffering mode 208 from the first buffering mode 206 in FIG. 2. Alternately or additionally, processor 102 may receive an indication that the user of the recording device 100 has been assigned to a task and, accordingly, transition to the second buffering mode 208 responsive to the indication.

In some embodiments, a pre-event condition may be determined in accordance with predetermined parameters. A parameter of the predetermined parameters may comprise a set of two or more values detectable by the recording device. The set of values may comprise a range or ranges of values. In some embodiments, a pre-event condition may be determined in accordance with a combination of parameters, wherein each parameter of the combination of parameters comprises a respective set of detectable values. For example, and in some embodiments, parameters to be used for determining a pre-event condition may include motion/position information. In some examples, the recording device 100 may further include motion/position sensors that provide the motion/position information. Motion/position information may comprise motion information and/or position information. A motion/position sensor may comprise a sensor configured to provide motion information and/or position information. In some examples, a motion/position sensor may provide position information over time by which motion information may be determined. In some embodiments, another device in proximity to the user may obtain its motion/position information and provide the recording device 100 with the obtained motion/position information. In some examples, motion information may be detected by analysis of video data, such as video data stored in the buffer 108 and/or video data recorded by any device coupled to the recording device 100. The pre-event condition may include motion information that is less than or greater than a threshold value. For example, the threshold value may include a minimum amount of rotation and/or translation of the recording device. In some examples, the motion information may be combined with another parameter to detect the pre-event condition. The other parameter may comprise time information. In such an example, the pre-event condition may comprise a threshold amount of motion information detected during a threshold amount of time. For example, threshold values for detecting a pre-event condition may include a minimum amount of rotation and/or translation of the recording device over a period of time. The minimum amount may be associated with the user being non-stationary. Motion information that indicates the recording device 100 is being rotated and/or translated to an extent greater than the minimum amount may indicate that the user is non-stationary, which may further be associated with a pre-event condition.

In some examples, the threshold value of motion information associated with a pre-event condition may include a predetermined speed. The pre-event condition may be detected if a speed of movement of the system exceeds or, alternately, falls below the predetermined speed. The speed of movement may be detected via a motion sensor, position sensor, and/or a motion/position sensor integrated with or communicatively coupled with the recording device 100. For example, the pre-event condition may be met if the recording device 100 is moving at a speed higher than a predetermined speed of 40 miles per hour (mph). The speed, including as detected by the recording device 100 to be higher than the predetermined speed, may indicate that the recording device 100 is positioned in a vehicle en route to an event.

In some examples, the pre-event condition may be met if the motion/position information obtained by the motion/position sensors or any device coupled to the recording device 100 is indicative that a change in speed is greater than a threshold change in speed. The speed may include a speed of movement of the recording device 100. The speed of movement may comprise a translational speed of movement of the recording device 100. For example, processor 102 may compare motion/position information obtained by the motion/position sensors to determine a change in speed. The change in speed may be further compared by the processor 102 to the threshold change in speed. The processor 102 may detect a pre-event condition in accordance with the comparing indicating that the change in speed is equal or greater than the threshold change in speed. The threshold change in speed may be indicative of a potential event. For example, a decrease in speed of greater than 30 mph may indicate that the recording device 100 and the user of the recording device 100 may have arrived at a location of an event.

In some embodiments, the change in speed may be determined over a period of time. The parameter of motion information may be combined with another parameter of time information to detect the pre-determined condition. For example, an increase in speed of greater than 5 mph within five seconds may indicate that a user wearing recording device 100 is involved in a foot chase. In accordance with a comparison identifying that motion information is greater than a threshold value within a period of time less than a threshold period of time, the recording device 100 may detect a pre-event condition and transition to the second buffering mode 208, buffering video data in a higher quality.

In some examples, a pre-event condition associated with motion/position information may be further determined in accordance with proximity of a vehicle. The proximity of the vehicle may be detected by the recording device. For example, the recording device 100 may determine that it is positioned near a vehicle in accordance with a manual input received via a user interface of the recording device 100 and/or a short-range wireless beacon broadcast by the vehicle. The recording device 100 may detect the proximity of the vehicle in accordance with detecting the manual input or, alternately, detecting the wireless beacon. An indication of the pre-event condition may comprise the wireless beacon received by the recording device 100. Upon receiving the wireless beacon, a pre-event condition associated with the recording device 100 being proximate to the vehicle may be determined by the recording device. In some embodiments, the proximity of the vehicle may include the recording device 100 being located inside the vehicle. For example, the recording device 100 comprising a body camera may determine it is positioned inside a vehicle in accordance with a strength of signal of a wireless beacon signal emitted by the vehicle. A first strength of signal, as detected by the recording device 100, equal or greater than a threshold value may cause the recording device 100 to detect a pre-event condition associated with the recording device 100 being disposed inside the vehicle. In some embodiments, a second strength of signal for the wireless beacon, as detected by the recording device 100, less than the threshold value may cause the recording device 100 to not detect this pre-event condition or, alternately, determine that this pre-event condition has not been detected.

In some embodiments, a pre-event condition may be detected based on a plurality of parameters that include proximity of a vehicle. For example, the proximity of the vehicle may modify one or more threshold values indicative of a pre-event condition. Alternately, a parameter having a first threshold value for a first pre-event condition may have a second threshold value different from the first threshold value when used in combination with another parameter to indicate a second pre-event condition of a plurality of pre-event conditions. For example, a threshold speed indicative of a pre-event condition when a recording device is proximate a vehicle may be greater than a threshold speed indicative of a pre-event condition when the recording device is not proximate the vehicle. For example, a threshold speed may be 7 mph when the recording device 100 is not proximate a vehicle and 40 mph when the recording device is proximate the vehicle.

In some embodiments, a pre-event condition associated with a proximity of a vehicle associated with a pre-event condition may further include a status of an equipment of the vehicle. Determining the proximity of the vehicle may further include determining the status of the equipment of the vehicle. The equipment of the vehicle may include one or more of a door, siren, and/or lightbar of the vehicle. The status may include, for example, a door being open or closed, a siren being activated or deactivated, and/or a lightbar being activated or deactivated. The vehicle and/or equipment may include one or more sensors to detect the status of the equipment. The vehicle and/or equipment may transmit the status of the equipment to a recording device. In some embodiments, the status may be transmitted responsive to a change in the status. For example, a vehicle may transmit a short-range wireless beacon responsive to detecting a change in status of siren from a deactivated state to an activated state. In embodiments, a pre-event condition may include a predetermined status of the equipment. The status of an equipment may be compared to the pre-determined status to detect the pre-event condition. For example, an activated status of a siren may be compared to a predetermined status for the siren and, responsive to the matching statuses, a pre-event condition may be detected. Detecting the predetermined status may both identify that a vehicle is proximate to a recording device and has the status associated with a pre-event condition monitored by the recording device.

In some embodiments, a pre-event condition may include a proximity with another device over time. The other device may be, for example, a vehicle and/or another recording device. The recording device 100 may periodically detect and store the proximity with the other device to track the proximity over time. The proximity over time may be further compared with a predetermined pattern associated with the pre-event condition. For example, a pre-event condition may be associated with when a distance between the recording device 100 attached to the user and a vehicle keeps increasing. Upon comparison of a tracked proximity over time with a predetermined pattern that includes an increased distance over a corresponding time, the recording device 100 may determine that the user is exiting the vehicle and transition to the second buffering mode 208.

In some embodiments, a pre-event condition may further include a sequence of predetermined patterns over time. For example, the recording device 100 may detect that it was proximate to a vehicle over a first period of time. Alternately or additionally, the recording device 100 may further determine that the vehicle and the recording device 100 were traveling at a same, non-zero speed during the period of time, indicating, for example, that the recording device 100 was disposed in the vehicle while it was moving. The recording device 100 may subsequently detect that a distance between the recording device 100 is increasing, indicating that the user with the recording device 100 has exited the vehicle. Upon comparison by the recording device 100, the proximity between the vehicle and the recording device 100 may match a predetermined pattern for information stored on the recording device 100. In accordance with the comparison indicating a match between the proximity and the predetermined pattern, the recording device may detect that the pre-event condition has occurred and change its buffering mode accordingly.

In some examples, a mobile phone or a wearable device of the user may further provide health information. The health information may include one or more vital signs of the user, such as a heart rate, an oxygen level, a blood pressure, etc., to the recording device 100. Upon receiving the one or more vital signs, the recording device 100 may detect whether the one or more vital signs are indicative of a pre-event condition. For example, a pre-event condition may include health information that is less than or greater than a threshold health value. The threshold health value may be indicative of user activity, such as the user running. Alternately or additionally, the threshold health value may be indicative of an internal condition of the user. For example, the internal condition may indicate that the user is tense. If the recording device 100 determines that the pre-event condition has occurred, the recording device 100 may transition to the second buffering mode 208. In some embodiments, a vital sign may be one of a plurality of parameters that collectively, upon being separately determined by a recording device, may be associated with a common pre-event condition.

In some examples, the pre-event condition may be based on an environmental condition around the recording device. For example, parameters to be used for determining a pre-event condition may include geographical information. The motion/position sensors of the recording device 100 or of a device in proximity to a user of the recording device 100 may obtain geographical information. In some embodiments, a mobile phone, a wearable device attached to the user, or a vehicle telematic system coupled to the recording device 100 may obtain its geographical information and provide the recording device 100 with the geographical information. In some examples, the pre-event condition may be met if the obtained geographical information is indicative that the recording device 100 or the user of the recording device 100 is located at a predetermined position or location.

In some examples, the pre-event condition may be met if a user of the recording device 100 or the recording device 100 in a vehicle is in proximity to a location of an event. For example, the recording device 100 may compare geographical information detected by the sensor to a predetermined location associated with a pre-event condition. For example, the recording device 100 may compare a position value detected by a GPS sensor to a location or position associated with the event. The location associated with the event may include a radius around a location separately communicated to the recording device 100. Responsive to the position value indicating the recording device 100 is located at the event in accordance with the comparison, the recording device 100 may determine a pre-event condition. In some embodiments, geographical information may be one of a plurality of parameters that in combination, once separately determined by a recording device, may be associated with a common pre-event condition.

In some embodiments, a pre-event condition may include a mode of another recording device. The other recording device may include, for example, a body-worn camera or a vehicle mounted camera. The mode may include the mode in which the other recording device is operating. For example, the recording device 100 may determine that one or more recording devices in proximity or in a same network carried by one or more team members of the user of the recording device 100 are operating in an event mode or a pre-event mode. The other devices may locally broadcast their mode of operation for receipt via wireless communication by the recording device 100. The recording device 100 may then compare the received mode(s) to a predetermined mode threshold or pattern to detect a pre-event condition. For example, and in some examples, if a number of one or more recording devices in proximity or in the same network is operating in an event mode is above a threshold, the recording device 100 may determine that the pre-event condition is met and may transition to the second buffering mode 208. In some embodiments, the mode may indicate a particular buffering mode of the other recording device and a pre-event condition may be detected accordingly. For example, if a number of one or more recording devices is operating in a highest quality buffering mode is above a threshold, the recording device 100 may determine that the pre-event condition is met and may transition to the second buffering mode 208. The threshold may include fixed number or a relative number. For example, the fixed number may include one other recording device, two or more other recording devices, or three other recording devices, five other recording devices, or greater than five other recording devices. In another example, a relative number or threshold may include a ratio of other recording devices. For example, the ratio may include half or a majority of the other recording devices or two-thirds of the other recording devices.

In some embodiments, the pre-event condition may include a predetermined audio signal or pattern. The recording device 100 may obtain audio accompanied with video collected in a scene and determine whether the pre-event condition has occurred by analyzing features of the audio representing an acoustic environment of the recording device 100. In some examples, the recording device 100 may transition to the second buffering mode when acoustic features of the acoustic environment of the apparatus are determined to be indicative of the pre-event condition. For example, the recording device 100 may detect a pre-event condition if a sound pressure level is above a threshold level. In some examples, the threshold level may be predetermined (e.g., 80 dB). Alternately or additionally, the threshold level may be determined by machine learning techniques that use models trained using acoustic features of events and pre-event scenes previously recorded. However, the acoustic features to be used are not limited to the sound pressure level. Other acoustic features of an acoustic environment associated with a pre-event condition may be determined using machine learning techniques that use models trained using acoustic features of events and pre-event acoustic scenes previously recorded.

In some examples, a pre-event condition may be based on an image analysis of image(s) recorded by the recording device. In some embodiments, the recording device 100 may detect the pre-event condition by analyzing image features of the buffered video data representing a visual environment of the recording device 100. In some examples, the recording device 100 may transition to the second buffering mode if at least a portion of image features in the buffered video data is indicative of a presence of a human face. Detecting the presence of a human face may be performed independent of, and without determining, for example, an identity of a person whose face is captured in video data. In some examples, detection of the presence of the human face may be determined by machine learning techniques that use models trained using image features of events and pre-event scenes previously recorded. In same or other embodiments, a pre-event condition may be determined independent of audio and/or video data captured by a recording device, thereby avoiding the energy expenditure and other resource consumption associated with processing such data.

In embodiments, a pre-event condition may include a plurality of parameters. The additional parameters may increase a likelihood that pre-determined usage of the recording device is accurately detected by the recording device. The plurality of parameters may include one or more parameters that alone do not indicate a pre-event condition has occurred, but the same one or more parameters in combination with another parameter of the plurality of parameters may indicate that the pre-event condition has occurred. For example, and in embodiments, the plurality of parameters may include one or more of a threshold value of motion information and/or a proximity of another equipment. The proximity of the equipment may further include a proximity of a vehicle to the recording device and/or a status of the equipment. For example, a detected speed of 35 mph for the recording device alone may not be associated with a pre-event condition, but a speed of 35 mph and a siren having an activated status may be associated with the pre-event condition. In this same example, a siren having an activated status alone and a speed of less than 35 mph may also not be associated with a pre-event condition, thereby refining the combinations of parameters associated with the pre-event condition and enabling the recording device 100 to transition to the second buffering mode 208 in an increasingly selective manner. In other examples, a pre-event condition may be associated with one or more other combinations of parameters. For example, a threshold decrease in speed and a door having a status of open may be associated with another pre-event condition. This pre-event condition may indicate, for example, that a user and the recording device have arrived at an event.

Examples of recording devices described herein may transition from one buffering mode to another buffering mode having a lower video quality level based on detection or receipt of indication of an idle condition. For example, the recording device 100 of FIG. 1 may, in accordance with executable instructions 116, transition from the second buffering mode 208 to the first buffering mode 206 responsive to occurrence of an idle condition. Recall that the recording device may transition to the higher quality level buffering mode responsive to a pre-event condition that is indicative of an increased likelihood of a recording event occurring. Here, a transition from the second buffering mode to the first buffering mode may be made responsive to a decrease in the likelihood of the recording event occurring. In some examples, the idle condition may be that the recording event has not occurred for a period of time after entering the second buffering mode (e.g., a higher quality level buffering mode). In some examples, an environmental change may occur that provides the idle condition.

Examples of idle conditions which may cause recording devices described herein to transition from a higher video quality level buffering mode to a lower video quality level buffering mode include conditions which may indicate a decreased likelihood of a recording event occurring. An idle condition may include a non-activation condition. An idle condition may be different from a recording condition. An idle condition may be different from a pre-event condition. In some examples, an idle condition may include different criteria or threshold values relative to a pre-event condition. For example, an idle condition may include a detected speed of equal or less than a first speed value and a pre-event condition may include another detected speed of equal or greater than a second speed value that is greater than the first speed value. For example, the first speed may include 25 miles per hour (mph) and the second speed may include 40 mph, such that a difference between the idle condition and pre-event condition is more than binary in nature. In another example, an idle condition may include a detected speed greater than a first speed value and a pre-event condition may include another detected speed of equal or less than a second speed value that is less than the first speed value. In this other example, an idle condition may be associated with a user riding in a vehicle, wherein video data captured by a wearable camera worn by the user may be less likely to capture an event or otherwise have less evidentiary value, while the pre-event condition may be associated with the user slowing down and/or exiting the vehicle, wherein the video data captured in this latter condition may be more likely to capture an event or otherwise have more evidentiary value.

In some embodiments, an idle condition may include proximity to a user equipment. The proximity of the equipment may indicate a technical context in which data for an event may be captured. The proximity of the equipment may indicate that an event is unlikely to occur. Alternately or additionally, the proximity of the equipment may indicate that captured data may have a low evidentiary value, insufficient to merit expenditure of the recording device's resources. In embodiments according to various aspects of the present disclosure, the equipment may include one or more of a vehicle and/or another recording device.

In embodiments, an idle condition may include motion information that is less than or greater than a threshold value. For example, a threshold value by which the idle condition is determined may include a minimum amount of rotation and/or translation of the recording device. Motion information from a motion/position sensor less than the threshold value may be used by processors 102 to detect the idle condition. In some examples, the motion information may be combined with another parameter to detect the idle condition. The other parameter may comprise time information. In such an example, the idle condition may comprise an amount of motion information less than a threshold value detected during a threshold amount of time. For example, threshold values for detecting a pre-event condition may include a baseline amount of rotation and/or translation of the recording device over a period of time. The baseline amount may be associated with the user being stationary. Motion information that indicates the recording device 100 is being rotated and/or translated to an extent less than the baseline amount may indicate that the user is stationary, which may further be associated with an idle condition.

In some embodiments, an idle condition may include proximity to a user equipment comprising a vehicle. Detecting the idle condition may include detecting the recording device is positioned inside the vehicle. For a recording device comprising a wearable camera, video data captured while the recording device is positioned inside the vehicle may largely capture a steering wheel, dashboard, seat, or other interior portion of a vehicle. Such video data may fail to capture information regarding an event that occurs outside of the vehicle. Accordingly, an idle condition may include a proximity of a recording device comprising the recording device being located inside a vehicle. In accordance with detecting such an idle condition, a buffering mode of the recording device may be modified such that the recording device buffers captured data at a lower quality.

In some embodiments, an idle condition may include proximity to a user equipment comprising another recording device. Detecting the idle condition may include detecting the recording device is proximate the other recording device. In some examples, the other recording device may include a vehicle-mounted recording device. For a recording device comprising a wearable camera, video data captured while the recording device is positioned proximate the other recording device may be redundant relative to video data captured by the recording device. Such video data captured by the wearable camera may fail to capture additional information regarding an event that occurs outside of the vehicle relative to video data captured by the in-vehicle recording device. In other example, detecting the recording device is proximate to another device may include detecting the recording device is physically coupled to the other recording device. In such examples, the other recording device may include, for example, an auxiliary camera, a peripheral camera, and/or a secondary camera. Such other recording devices may consume additional power from a same power supply as the recording device such that, by buffering data at a lower quality may preserve battery life under such conditions. Such other recording devices might also be able to alternately capture alternate, potentially redundant information regarding a subsequent event. Accordingly, an idle condition may include a proximity of a recording device comprising the recording device being proximate another recording device. In accordance with detecting such an idle condition, a buffering mode of the recording device may be modified such that the recording device buffers captured data at a lower quality.

In embodiments, an idle condition may include proximity of multiple equipment. The proximity of the multiple equipment may improve detection of a technical context in which a recording device is disposed, thereby improving chronological alignment of when a lower quality buffering mode is employed and when events are not occurring. For example, detecting an idle condition may include detecting proximity of both another recording device and a vehicle. Responsive to detecting the multiple equipment, occurrence of the idle condition may be determined by a recording device.

In some embodiments, an idle condition may include detecting proximity of another recording device and a recording status of the other recording device. The recording status may indicate whether pre-event data is currently being recorded by the other recording device. For example, a wearable camera may detect its proximity to an in-vehicle recording device in accordance with receiving a short-range wireless beacon from the in-vehicle recording device. The beacon may further include information that identifies a recording status of the in-vehicle recording device. The idle condition may include the proximity of the wearable camera to the in-vehicle recording device and the recording status of the in-vehicle recording device being one of event recording or pre-event recording. In such an example, the idle condition may not be detected in accordance with the proximity of the wearable camera to the in-vehicle recording device, but the recording status of the in-vehicle recording device being determined to be standby, not recording, or operating in neither of a pre-event mode and an event mode.

In some embodiments, the executable instructions for operating a system using multiple buffering modes 116 may include executable instructions which, when executed by the one or more processors 102, cause the recording device 100 to monitor one or more parameters to detect an idle condition of the recording device 100. The idle condition may be detected by the recording device 100 itself. For example, processor 102 may detect the idle condition in accordance with information with one or more sensors integrated with the recording device 100. In some examples, the recording device 100 may transition to the first buffering mode (e.g., the second buffering mode 208 in FIG. 2) based on the detected idle condition. In some examples, the idle condition may be based on an attribute of the user of the recording device. The attribute of the user may be detected by the recording device. The attribute of the user may be associated with a manner in which the user interacts with the recording device. The recording device may include one or more sensors for detecting parameter(s) that indicate the attribute of the user. In some embodiments, a parameter to be used for determining an idle condition may include motion information. In some examples, when the recording device 100 is detected in a vehicle and the moving speed of the recording device 100 attached to a user is within a predetermined speed range (e.g., 15-40 mph), the recording device 100 may determine an idle condition in which the recording device 100 is positioned behind a steering wheel and, accordingly, the recording device 100 may transition to the first buffering mode 206. In some examples, when the moving speed of the recording device 100 attached to a user and the speed of a vehicle carrying the user are similar, the recording device 100 may determine an idle condition associated with the recording device 100 being positioned inside the vehicle and, accordingly, the recording device 100 may transition to the first buffering mode, buffering video data in a lower quality than the quality in the second buffering mode.

In some examples, an idle event condition may be met if motion/position information obtained by the motion/position sensors or a device coupled to the recording device 100 is indicative that a change in speed is greater than a threshold change in speed. For example, processor 102 may compare motion/position information obtained by the motion/position sensors to determine a change in speed. The change in speed may be further compared by the processor 102 to the threshold change in speed. The processor 102 may detect an idle condition in accordance with the comparing indicating that the change in speed is equal or greater than the threshold change in speed. The threshold change in speed may be indicative of the recording device being positioned in a vehicle. For example, an increase in speed of greater than 30 mph may indicate that the recording device 100 and the user of the recording device 100 are positioned inside a vehicle.

In some examples, an attribute of the user on which the idle condition may be determined may include the user being unassociated with a task. As discussed above, the task may include an activity performed, or to be performed, by the user of the recording device. The task may include, for example, responding to a call for service. A user that is not associated with a task may be available to respond to a subsequent task that arises. A lack of engagement or association of the user with the task may indicate that an event which data may be selectively recorded is unlikely to occur. The idle condition may include receiving and/or detecting an indication by the recording device that the user of the recording device is unassociated with (e.g., not engaged in, not assigned to, etc.) with the certain task. In some examples, detecting the user is unassociated with the task may include detecting, by the recording device, an absence of an acceptance of the task by the user. The idle condition may be indirectly detected in accordance with detecting a lack of acceptance of the task by the user. In examples, the idle condition may be directly indicated by an indication received by a recording device. In such examples, the task and association or non-association of the task with the user may not be separately detected or detectable by the recording device without the indication. The user of the recording device may be associated with the task prior to the indication being received and/or detected by the recording device. For example, the recording device 100 may receive an indication that an assigned and/or accepted task has ended and/or is no longer associated with a user of the recording device 100. A computer aided dispatch (CAD) system in communication with the recording device 100 may transmit an indication that the user of the recording device that a call for service has been cancelled, a call for service has concluded, and/or the user has not been assigned to a call for service. In accordance with receiving the indication, the recording device may store information in a memory of the recording device indicating that the certain task has not been associated with the user. In some examples, disassociation of the user from a task may be an idle condition that may cause the recording device 100 to transition from a higher power buffering mode to a lower power buffering mode. For example, processor 102 may receive the indication that the user of the recording device 100 is not assigned to a task and, responsive to receiving the indication, transition to the first buffering mode 206 in FIG. 2. Alternately or additionally, processor 102 may detect that an indication of an association between the user of the recording device 100 and a task has not been received and, accordingly, transition to the first buffering mode 206 in FIG. 2.

In some examples, the idle condition may be based on an environmental condition around the recording device. The environmental condition may be detected by the recording device itself via one or more sensors integrated with the recording device. Alternately or additionally, the environmental condition may be determined in accordance with information received by the recording device from an external source. The external source may include, for example, one or more of another computing device and/or an external sensor, each of which may be in communication with the recording device via a communication interface of the recording device.

In some embodiments, the environmental condition may be determined in accordance with geographical information. Parameters used for determining the idle condition may include geographical information. In some examples, the idle condition may be met if the recording device 100 is away from a location of an event of interest. For example, recording device 100 may receive information via a communication interface regarding a location of the event. Recording device 100 may also determine its location (i.e., a location of the recording device 100) in accordance with position information received from a position sensor integrated with recording device 100. In accordance with a distance between the location of the event and the location of recording device 100, recording device 100 may determine an idle condition. For example, the idle condition may be determined in accordance with the distance being greater than a threshold distance.

In some embodiments, the environmental condition may include proximity to one or more other devices. The devices may include other equipment that may be associated with a user of the recording device. For example, the devices may include a vehicle, a conducted electrical weapon, or other used device. In certain further embodiments, the environmental condition may include a mode of at least one recording device of the one or more devices. For example, the recording device 100 may detect whether one or more devices in proximity or in the same network as recording device 100. Recording device 100 may receive geographical information associated with each device of the one or more devices to determine a respective proximity of each device of the one or more devices. Recording device 100 may also further communicate with a recording device of the one or more devices, if any, to obtain mode(s) of the one or more devices. In some examples, the recording device 100 may determine that the idle condition is met if the recording device 100 determines that there is no device carried by one or more team members of the user of the recording device 100 in proximity or in the same network, or none of the one or more devices in proximity or in the same network carried by one or more team members of the user of the recording device 100 are operated in an event mode. In some examples, if fixed number or, alternately, a ratio of one or more recording devices in proximity or in the same network that are operating in an event mode is below a threshold (e.g., zero, one, the minority), the recording device 100 may determine that the idle condition is met and may transition to the first buffering mode.

In some embodiments, the environmental condition may include audio signals detected at a location of the recording device 100. The recording device 100 may obtain audio accompanied with video collected in a scene and determine whether an idle condition is met by analyzing features of the audio representing an acoustic environment of the recording device 100. In some examples, the recording device 100 may transition to the first buffering mode if acoustic features of the acoustic environment of the apparatus indicative of a pre-event condition are absent in the audio. In some examples, the recording device 100 may determine an idle condition if a sound pressure level is below a threshold level. In some examples, the threshold level may be predetermined (e.g., 80 dB). In some examples, a threshold level associated with an idle condition may be different from a threshold level associated with a pre-event condition. For example, the pre-event condition may be associated with a threshold level or value equal or greater than 100 dB, while the idle condition may be associated with a threshold level or value equal or less than 30 dB. In some examples, the threshold level may be determined by machine learning techniques that use models trained using acoustic features of transition periods from pre-event scenes to idle scenes previously recorded. However, the acoustic features to be used are not limited to the sound pressure level. Any acoustic features that may be associated with an acoustic environment or an idle scene may be used to determine the idle condition using machine learning techniques that use models trained using acoustic features of transition periods from pre-event scenes to idle scenes previously recorded.

In some embodiments, a predetermined idle condition may be determined in accordance with a connection status of the recording device 100. The connection status may indicate whether an interface of recording device 100 is coupled to an external source. The interface may include a physical interface of recording device 100. For example, the interface may include a wired interface via which power to recharge a power supply of recording device 100 may be received. Alternately or additionally, the interface may include a wired communication interface by which data recorded for an event may be offloaded from the recording device 100. The recording device 100 may determine an idle condition when the recording device 100 is supplied with power. For example, the recording device 100 may detect whether the recording device 100 is connected to a charging device (e.g., a battery, a power bank, etc.) or a power outlet via a power supply cable or a dock. If the recording device 100 is supplied with power, the recording device 100 may determine that an idle condition has been met, and transition to the first buffering mode or the standby mode, which may increase a charging speed.

In some embodiments, an idle condition may be determined in accordance with a type of external power supply to which it is connected. For example, recording device 100 may be connected to a first type of power supply that comprises a combined power and data connector. The first type of power supply may comprise a non-magnetic connector. The first type of power supply may be provided at a docking station. Via this type of power supply, a power source of recording device 100 may be recharged while data is offloaded from the recording device. The recording device 100 may also be connected to a second, different type of power supply that comprises a power connection. The second type of power supply may lack a data connector. The second type of power supply may comprise a magnetic connector. The second type of power supply may be provided in the field. For example, the second type of power supply may be provided in a vehicle and/or via a portable battery charging device. Via this type of power supply, a power source of recording device 100 may be recharged, but data may not be offloaded from the recording device via the connector of this power supply. In embodiments, determining an idle condition may comprise determining the recording device 100 is connected to the second type of power supply. In accordance with being coupled to the first type of power supply, an idle condition may not be detected.

In some embodiments, a predetermined idle condition may be determined in accordance with a status information of the recording device 100. The status information may indicate an internal operating condition of the recording device. The status information may be self-detected by the recording device 100. For example, the status information may include an amount of unused memory available for recording video data and/or an amount of power remaining in a battery integrated in the recording device 100. In accordance with the status information indicating that the amount of unused memory available is less than a threshold value and/or the amount of power remaining is less than a threshold value, recording device 100 may determine that an idle condition has been met.

In some embodiments, a predetermined idle condition may be determined in accordance with video information detected for the recording device 100. The video information may be associated with video data captured by the recording device 100. In some embodiments, the video information may include an amount of motion represented in the video data. Recording device 100 may detect a rate of motion represented in captured video data. In accordance with the amount of motion being less than a threshold amount, the idle condition may be detected.

In some examples, the pre-event condition indicative of the increased probability may be met if the recording device 100 detects an interruption of an idle condition.

Examples of recording device described herein may transition to a recording mode responsive to the occurrence of a recording condition. For example, the recording device 100 of FIG. 1, in accordance with executable instructions 116, may transition to the recording mode 204 responsive to the occurrence of a recording condition. Note that the recording device may transition to the recording mode 204 from any of the standby mode 204, first buffering mode 206, or second buffering mode 208. That is, on occurrence of the recording condition, recording may begin regardless of what mode the recording device was in when the recording condition occurred. In embodiments, the recording condition includes a deterministic condition. Each occurrence of the recording condition indicates an event is occurring for which data is to be recorded for subsequent review. Each occurrence of the recording condition results in data being recorded. Examples described herein may seek to identify appropriate pre-event conditions such that the recording device may typically be in the second buffering mode 208 at the time the recording condition occurs (e.g., the recording device has accurately predicted a recording event), however, the prediction may not be accurate or possible in all cases, and a recording condition may occur when the recording device 100 is operating in any mode.

In embodiments, a recording condition may be based on an action by a user. The user may include a user of recording device 100 or another user in the vicinity of the recording device 100. Determining the recording condition may include detecting, determining, and/or receiving information indicating the action by the user. In some embodiments, the action may include one or more of a direct action by the user and/or an indirect action of the user.

In embodiments, a recording condition may be based on a direct action by a user. The direct action may include a manual interaction between the user and the recording device 100. The recording condition may be associated with the user of the recording device manually requesting that recording begin. The recording condition may occur responsive to the user providing an input indicative of a recording instruction. The input may be provided via a user interface of the recording device. The input may include actuation of the user interface of the recording device. For example, the user may press a button of a user interface of recording device 100 to cause the recording device to enter a recording mode, thereby activating the recording of video data by the recording device 100. In same or different embodiments, an input indicative of a recording instruction may include a push of a button, a tap of the device, a gesture to the device, a spoken command to the device, or other input. The user interface of recording device by which the direct action is detected may include the button, one or more haptic and/or other pressure sensors configured to detect the tap and/or the gesture, and/or a microphone configured to detect the spoken command. In embodiments, the recording device 100 may generate an activation signal responsive to receiving the input. For example, the user interface of the recording device 100 may transduce a force of a manual input into an activation signal comprising an electrical signal. The recording condition may include receiving, by the one or more processors 102 of the recording device 100, an activation signal indicating the input has been provided via a user interface of recording device 100. In some embodiments, an input associated with a recording condition may be different from any input associated with a pre-event condition and/or idle condition. In embodiments, an element of a user interface associated with a recording condition may be different from each other element of a user interface, if any, associated with a pre-event condition or idle condition. For example, recording device 100 may comprise a dedicated button usable to indicate a recording condition. A pre-event condition or idle condition may be detected in accordance with operation, or lack of operation, of one or more other elements of the same user interface, different from the dedicated button or other user interface element.

In embodiments, a recording condition may be based on an indirect action by a user. The indirect action may not be expressly applied to a recording device itself, yet the recording device may begin recording data responsive to the indirect action. For example, the recording device 100 may automatically perform one or more operations in accordance with information received from another device and/or detected by the recording device 100 in order to avoid requiring further user action to activate recording by the recording device 100. In embodiments, the indirect action may be detected by one of an equipment in communication with the recording device and a sensor of the recording device.

In some embodiments, an indirect action may be associated with the user operating an equipment. The equipment may be separate from a recording device that begins recording responsive to the indirect action. The equipment may be in communication with the recording device. For example, the equipment may be in communication with the recording device 100 to enable the recording device 100 to receive an activation signal from the equipment. Responsive to a predetermined operation being applied to the equipment by the user, the equipment may transmit the activation signal to the recording device 100. In accordance with receiving the activation signal, the recording device may determine that a recording condition has occurred.

In embodiments, the equipment may include portable user equipment. The equipment that may be carried, driven, or otherwise be provided with a user at an event. The equipment may provide a non-recording function associated with the event. The equipment may enable a user to respond to an event in a manner that is not enabled by a recording device. For example, the equipment may include a vehicle, weapon, or holster. The equipment may be configured to detect one or more predetermined operations performed with the equipment. The vehicle may include at least one vehicle sensor configured to detect one or more of a change in speed of the vehicle, a change in acceleration of the vehicle, an opening or closing of a door of the vehicle, an activation or deactivation of a lightbar of the vehicle, and/or an activation or deactivation a siren of the vehicle. Alternately or additionally, the weapon may include at least one weapon sensor configured to detect a removal of the weapon from a holster, activation or deactivation of a safety of the weapon, and/or launch of a projectile from the weapon. Alternately or additionally, the holster may include at least one holster sensor configured to detect insertion and/or removal of a weapon holster from the holster.

In embodiments, and responsive to detecting a predetermined operation of the equipment, the equipment may be configured to transmit a notification identifying the operation. For example, the equipment may be configured to broadcast a notification using a short-range wireless communication protocol. The notification may include a beacon, wherein the beacon includes information identifying the predetermined operation. For example, an equipment comprising a conducted electrical weapon may broadcast a beacon responsive to a user unholstering the conducted electrical weapon. The beacon may include information identifying that the conducted electrical weapon has been unholstered. Alternately or additionally, an equipment comprising a vehicle may broadcast a wireless notification responsive to a user activating a siren attached to the vehicle. The beacon may include information identifying that the sirens have been activated. In embodiments, an activation signal transmitted within a system comprising an equipment and a recording device may include a notification transmitted from the equipment to the recording device.

In embodiments, the recording device 100 may determine a recording condition in accordance with receiving a notification from an equipment. For example, the recording device 100 may receive a beacon from an equipment that identifies a predetermined operation detected by the equipment. In accordance with the predetermined operation being identified to the recording device 100 by the notification, the recording condition may be automatically determined by the recording device 100. For example, processor 102 of the recording device 100 may receive information via a received wireless notification received by a communication device of recording device 100 and, responsive to the predetermined operation identified by the wireless beacon, automatically determine a recording condition has occurred. In embodiments, and in accordance with a manner in which the recording device 100 is configured to automatically respond to predetermined operations of nearby equipment, receiving a notification may include receiving an activation signal by the recording device 100.

In some embodiments, different status information for a same equipment may be associated with a pre-event condition or a recording condition. An equipment may have a plurality of status information. For example, a conducted electrical weapon may have a holstered status, unholstered status, and a safety off status. In embodiments, two or more statuses of the safety information may be associated with different conditions. For example, recording device 100 may detect an idle condition in accordance with first status information of the weapon comprising a holstered status, a pre-event condition in accordance with second status information of the weapon comprising an unholstered status, and an event condition in accordance with third status information of the weapon comprising a safety off status. Such an arrangement may enable different status information to indicate whether an event is less likely to occur, is more likely to occur, or has occurred, and adjust manner in which video data is stored by the recording device accordingly.

In some embodiments, a recording condition may be based on an indirect action detected by a sensor of the recording device. The indirect action may indicate an action by a user of the recording device. For example, the action may include a movement and/or location at an event. The recording device 100 may include one or more of a global positioning system (GPS) sensor, an accelerometer, a gyroscope, and/or an inertial motion sensor. The recording device 100 may compare a value detected by the sensor to a predetermined value or threshold associated with a recording condition. For example, the recording device 100 may compare a position value detected by a GPS sensor to a location associated with the event. The location associated with the event may include a radius around a location separately communicated to the recording device 100. Responsive to the position value indicating the recording device 100 is located at the event in accordance with the comparison, the recording device 100 may automatically generate an activation signal. Alternately or additionally, the recording device 100 may compare a speed value detected by motion sensor to a predetermined speed threshold. The speed threshold may include, for example, a value of 75 mph. In embodiments, the speed threshold may be greater than a speed value associated with a pre-event condition. Responsive to the speed value exceeding the speed threshold in accordance with the comparison, the recording device 100 may automatically generate an activation signal. Responsive to the recording condition, the device may stop buffering data and may begin recording video data.

In embodiments, different conditions may be associated with different thresholds for a same parameter. For example, a pre-event condition may be associated with a first threshold and a recording condition may be associated with a second threshold different from the first threshold. An idle condition may be further associated with a third threshold different from the second threshold. The third threshold may be further different from the second threshold. The different thresholds may be further compared against a same information or parameter. For example, each of the first and second thresholds may be compared with motion information determined by recording device 100. In other embodiments, the same information may include one or more of positional information, change in speed information, health information, or other types of information associated with conditions discussed elsewhere herein. The information may be compared against the different thresholds in a continuous manner such that changes in conditions for the recording device 100 may be automatically detected.

Examples of recording devices described herein may exit a recording mode and return to one of multiple buffer modes and/or a standby mode responsive to occurrence of a deactivation condition. For example, the recording device 100 of FIG. 1 may determine an occurrence of a deactivation condition in accordance with the executable instructions 116—for example, the recording device may determine that an event has concluded. The conclusion of an event in some examples may be determined responsive to a user input—e.g., a touch of a button, gesture, tap, or other command to the recording device to stop recording. Responsive to the deactivation condition, the recording device may return to a standby mode, or any of the buffering modes. In some examples, the recording device may return by default after recording to a lower power buffering mode, such as first buffering mode 206.

In embodiments, different deactivation conditions may be determined in accordance with different user inputs. The different deactivation conditions may cause the recording device 100 to change its operation to different modes. For example, a first user input may comprise a first deactivation condition associated with a standby mode and a second user input may comprise a second deactivation condition associated with a pre-event mode. The first user input may be received, for example, via a power control element of a user interface of recording device 100 and the second user input may be received, for example, via a recording control element of the user interface of recording device 100 different from the power control element.

As described above, an idle or pre-event condition may be detected by the recording device 100 based on various factors or parameters, such as an attribute of the user of the recording device as detected by the recording device 100, an environmental condition around the recording device 100, an image analysis of image(s) recorded by the recording device 100, movement of the recording device 100, movement and/or vital signs of the user obtained from a wearable device in proximity, noise surrounding the recording device 100, video recording by another imaging apparatus in proximity or in the same network carried by a team member of the user of the recording device 100, fast motion detected in the buffered video data, etc. In some embodiments, the recording device 100 may use machine learning techniques to detect an idle condition and/or a pre-event condition. In some embodiments, the machine learning technique may be pre-trained to assess pre-event and/or idle conditions. Features used to train the machine learning technique and/or determine the behavior of the machine learning technique may be any parameters which may be used for identifying a nature of a pre-event scene.

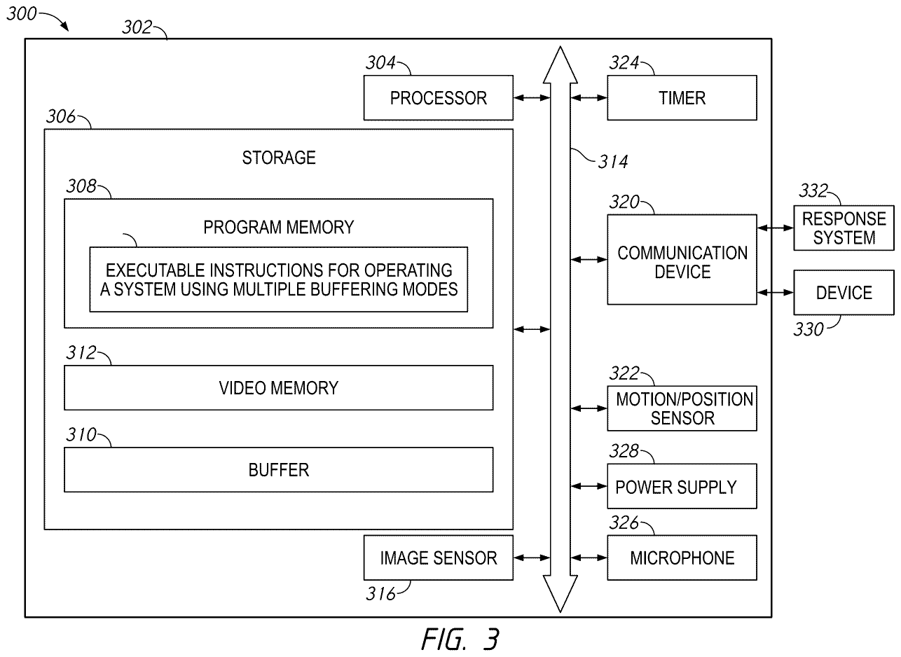

FIG. 3 is a block diagram of a system 300 including a recording device 302 according to an embodiment of the present disclosure. The recording device 302 may include one or more processors 304, one or more storage devices 306, one or more image sensors 316 and one or more connections 314. The one or more storage devices 306 may include a program memory 308 including executable instructions for operating a system using multiple buffering modes 318, video memory 312 and one or more buffers 310. The recording device 302 may further include additional components shown as timer 324, communication device 320, motion or position sensor 322, and microphone 326, which may additionally be connected to processor 304, image sensor 316, and/or storage devices 306. The system 300 includes an additional computing system, response system 332, which may be in communication with recording device 302. Additional devices, such as device 330 may also be in communication with recording device 320.

The components shown in FIG. 3 are exemplary only. Additional, fewer, and/or different components may be used in other examples. In some embodiments, the recording device 302 may be used to implement and/or may be implemented by the recording device of FIG. 1. For example, the one or more processors 304, the one or more storage devices 306, the one or more image sensors 316 and the connectors 314 of FIG. 3 may be implemented using the one or more processors 102, the one or more storage devices 104, the one or more image sensors 114, and the connector 112 of FIG. 1 respectively. Thus, detailed description of these components is not again provided with specific reference to FIG. 3 for brevity.

In some examples, the recording device 302 may further include one or more communication devices 320. The one or more communication devices 320 may couple the recording device 302 to one or more networks and/or other computing systems using wireless or wired communications. The communication devices 320 may be one or more communication interfaces. The wireless communications may include, for example, Wi-Fi; cellular telecommunications such as CDMA, GSM, EV-DO, 3G, 4G, and 5G, etc. ; short distance communications such as BLUETOOTH; near field communications (NFC); etc. The wired communications may include communications via Ethernet, for example.

In some examples, the recording device 302 may communicate with another computing system, such as response system 332, via the communication device 320. The response system 332 may include one or more of a computer-aided dispatch system and/or an evidence management system. In some examples, such as when the recording device 302 is a body-worn camera used by an officer, the officer or other user may accept a task. The task may include a predetermined task. For example, the task may include responding to a call for service previously received by the response system. A response indicating acceptance of the task may be provided from the officer to the response system 332. The response may be communicated to the response system 332 via recording device 302. For example, the response may include a user input indicating the acceptance of the task received via the user interface 323 of the recording device 302. The recording device 302 may further provide the response in a communication from the recording device 302 to the response system 332, wherein the recording device 302 may access the communication to detect the response. In embodiments, the recording device 302 may further determine the pre-event condition is met when a response detected in a communication with the response system 332 is indicative of the acceptance of the task. In accordance with the acceptance of the task, the recording device 302 and a user of the recording device 302 may be associated with the task. In some examples, determining a pre-event condition may include receiving one or more of an input indicating the acceptance of the task and/or a detecting a response in a communication to another computing system, wherein the response is indicative of an acceptance of a predetermined task.

In some embodiments, communication between recording device 302 and response system 332 may include a request associated with the task. The request may include information identifying the task. For example, a request to respond to a call for service may come from the response system 332. Recording device 302 may receive information indicating the request via the communications devices 320. The request may be received by recording device 302 prior to a response to the request being provided in a communication from the recording device 302 to the response system 332. In some examples, a response to the request indicating the acceptance of a task may be the pre-event condition that may cause the recording device 302 to transition from a lower power buffering mode to a higher power buffering mode. In some examples, determining a pre-event condition may include receiving one or more of an input indicating the acceptance of the task and/or a request to respond another computing system in communication with recording device 302.

In various embodiments, power supply 328 (e.g., power source) may be configured to provide power to one or more electric and/or electronic components of the recording device 302. Power supply 328 may comprise an integral power supply for recording device 302. Power supply 328 may comprise an internal power supply for recording device 302. By including power supply, 328, recording device 302 may be enabled to operate in a portable manner. Power supply 328 may enable recording device 302 to perform operations of a wearable camera. By including power supply, 328, recording device 302 may be enabled to operate while disconnected from an external power supply. The power supply 328 may provide energy for operating electronic and/or electrical components (e.g., parts, subsystems, circuits, etc.). The power supply may provide electrical power. The power supply may include a battery. The energy of the power supply may be renewable or exhaustible, and/or replaceable. For example, the power supply may comprise one or more rechargeable batteries. In response to the power supply comprising one or more rechargeable batteries, the power supply may be in electric communication with a power charging port to allow recording device 302 to receive electrical power from an external source to charge the power supply 328. In accordance with the use of different buffering modes disclosed herein, power stored in power supply 328 may be conserved, thereby enabling recording device 302 to capture data for longer periods of time. The use of the multiple buffering modes by recording device 302 may provide the technical benefit of enabling recording device 302 to be disconnected from an external power supply for longer periods of time, while still enabling recording device 302 to capture data during these periods of time.

In some embodiments, the executable instructions for operating a system using multiple buffering modes 318 may further include executable instructions which, when executed by the one or more processors 304, further cause the recording device 302 to monitor one or more parameters to detect an idle condition and/or pre-event condition. In some examples, the recording device 302 may transition to the second buffering mode (e.g., the second buffering mode 208 in FIG. 2) based on the detected pre-event condition. In same or different examples, the recording device 302 may transition to a lower power buffering mode (e.g., the first buffering mode 206 in FIG. 2) based on the detected idle condition.

In some embodiments, parameters to be used for determining an idle condition and/or a pre-event condition may include motion information. The motion information, also referred to herein as motion/position information, may include information indicating a movement and/or a position of recording device 302. The occurrence of the idle condition and/or the pre-event condition may be detected in accordance with the motion information being processed by processor 304. In some examples, the recording device 302 may further include motion/position sensors 322. For example, the motion/position sensors 322 may include an accelerometer, a gyroscope, inertial motion unit, etc., which obtains motion/position information of the recording device 302. In some embodiments, another device 330 in the system 300 coupled to the recording device 302, such as a vehicle telematic system, a mobile phone or a wearable device attached to the user, may obtain its motion/position information and provide the one or more communication devices 320 with the obtained motion/position information. In some examples, motion may be detected by analysis of video data, such as video data stored in the buffer 310 of the recording device 302 and/or video data of any device 330 coupled to the recording device 302 or in communication with the recording device 302.

In some examples, the pre-event condition may be met if the recording device 302 in a vehicle is moving at a speed higher than a predetermined speed (e.g., 40 mph). In some examples, the pre-event condition may be met if the motion/position information obtained by motion/position sensors 322 or any device coupled to the recording device 302 is indicative that a speed of movement is higher than a predetermined speed (e.g., 40 mph). In some embodiments, the pre-event condition may be further determined in accordance with the recording device 302 receiving additional environmental information. The additional environment information may include, for example, information regarding a status of another device in communication with recording device 302. For example, the pre-event condition may be determined when environmental information is received indicating a siren of a vehicle proximate to the recording device 302 is activated and, accordingly, the recording device 302 may transition to the second buffering mode, buffering video data in a higher quality.

In some examples, when the recording device 302 detects a it is proximate to a vehicle and the moving speed of the recording device 302 attached to a user is within a predetermined speed range (e.g., 15-40 mph), the recording device 302 may determine an idle condition associated with the user being behind a steering wheel and, accordingly, the recording device 302 may transition to the first buffering mode. In such examples, determining the pre-event condition may also include receiving other environmental information. For example, in such examples, environmental information received by the recording device 302 may indicate the siren of the vehicle is not activated and, in accordance with this information, the idle condition may be determined. In some examples, when the moving speed of the recording device 302 attached to a user and the speed of a vehicle carrying the user are similar, an idle condition associated with the user sitting in the vehicle may be determined and, accordingly, the recording device 302 may transition to the first buffering mode, buffering video data in a lower quality than the quality in the second buffering mode.

In some examples, the pre-event condition may be met if the motion/position information obtained by motion/position sensors 322 or any device coupled to the recording device 302 is indicative that a speed of movement is lower than a predetermined speed (e.g., 15 mph), or indicative that either the user engaged with an event on foot or a probability that a vehicle carrying the user is approaching an event scene to unload the user soon, and the recording device 302 may transition to the second buffering mode, buffering video data in a higher quality. Accordingly, the recording device 302 may be operated in multiple different buffering modes in accordance with different ranges of motion/position information, where the different ranges may include multiple, non-sequential ranges for a same buffering mode and/or a range associated with a lower quality buffering mode intermediate to higher and lower ranges associated with higher quality buffering mode(s).

In some embodiments, parameters to be used for determining an idle condition and/or a pre-event condition may include geographical information. For example, the motion/position sensors 322 may include a GPS or global navigation satellite system (GNSS) receiver which obtains geographical information of the recording device 302. In some embodiments, a mobile phone, a wearable device attached to the user, or a vehicle telematic system coupled to the recording device 302 may obtain its geographical information and provide the one or more communication devices 320 with the geographical information. In some examples, the pre-event condition may be met if the geographical information obtained by motion/position sensors 322 or any device 330 coupled to the recording device 302 is indicative that the recording device 302 or the user of the recording device 302 is disposed at a predetermined position. The predetermined position may include a physical location. The predetermined position may include an absolute or relative position. For example, a predetermined absolute position may include a physical location of a building. The building may include, for example, a police station of an agency associated with the recording device 302. In accordance with geographical information obtained by motion/position sensors 322 or any device 330 coupled to the recording device 302 is indicative that the recording device 302 is located at the predetermined absolute position, the idle condition may be determined. The recording device may be considered to be located at the predetermined absolute position in accordance with the geographical information being equal to the predetermined absolute position and/or a predetermined distance from the predetermined absolute position. The predetermined distance may include, for example, 100 feet, 200 feet, 500 feet, or 1000 feet in embodiments according to various aspects of the present disclosure.

In some examples, the pre-event condition may be met if a user of the recording device 302 or the recording device 302 in a vehicle is in proximity to a location of an event of interest. In some examples, when a distance between the recording device 302 and a vehicle keeps increasing, the recording device 302 may determine that the user is exiting the vehicle, and transition to the second buffering mode. In some examples, the recording device 302 may communicate with one or more devices 330 with imaging functionalities in the system 300 via the one or more communication devices 320 and obtain information for determining the pre-event and/or idle conditions. For example, at least one of the one or more communication devices 320 may communicate with the one or more device 330 in proximity or in the same network to obtain a mode of the one or more devices 330. In some examples, the recording device 302 may determine that the pre-event condition is met and may transition to the second buffering mode, if the recording device 302 determines that the one or more devices 330 in proximity or in the same network carried by a team member of the user of the recording device 302 are either operated in a recording mode or a higher quality level buffering mode. The higher quality level buffering mode may include a highest quality buffering mode of a recording device of the other devices 330, such as second buffering mode 208 with brief reference to FIG. 2. This pre-event condition may be determined based on the geographical information and the mode received from the one or more devices 330 by the one or more communication devices 320, in addition to the geographical information of the recording device 302. In some examples, if a ratio of the one or more devices 330 in proximity or in the same network either recording video or in the higher quality level buffering mode-is above a threshold (e.g., the majority), the recording device 302 may determine that the pre-event condition is met and may transition to the second buffering mode.

In some examples, a mobile phone or a wearable device of the user may further provide one or more vital signs of the user, such as a heart rate, an oxygen level, a blood pressure, etc., to the one or more communication devices 320. Upon receiving the one or more vital signs at the one or more communication devices 320, the recording device 302 may detect whether the one or more vital signs are indicative of a pre-event condition. For example, the vital signs may indicate the user is running or the user is tense. If the recording device 302 determines the pre-event condition, the recording device 302 may transition to the second buffering mode.

In some embodiments, the recording device 302 may further include one or more audio recording devices, such as one or more microphones 326. The one or more microphones 326 may collect audio accompanied with video collected in a scene, and the one or more processors 304 may store the audio data together with or separately from the video data in the storage devices 306. The recording device 302 may determine a pre-event condition by analyzing features of the audio representing an acoustic environment of the recording device 302. In some examples, the recording device 302 may transition to the second buffering mode if acoustic features of the acoustic environment of the apparatus is indicative of the pre-event condition. In some examples, the recording device 302 may determine the pre-event condition if a sound pressure level is above a threshold level. In some examples, the threshold level may be predetermined (e.g., 80 dB). In some examples, the threshold level may be determined by machine learning techniques that use models trained using acoustic features of events and pre-event scenes previously recorded. However, the acoustic features to be used are not limited to the sound pressure level. Any acoustic features that may be associated with an acoustic environment or a pre-event scene may be used to determine the pre-event condition using machine learning techniques that use models trained using acoustic features of events and pre-event scenes previously recorded.

In some embodiments, the recording device 302 may determine the pre-event condition or in the event by analyzing image features of the buffered video data representing a visual environment of the recording device 302. In some examples, the recording device 302 may transition to the second buffering mode if at least a portion of image features in the buffered video data is indicative of a presence of a human face. In some examples, detection of the presence of the human face may be determined by machine learning techniques that use models trained using image features of events and pre-event scenes previously recorded.

In some embodiments, the executable instructions for operating a system using multiple buffering modes 318 may further include executable instructions which, when executed by the one or more processors 304, further cause the recording device 302 to monitor one or more parameters to detect an idle condition of the recording device 302. In some examples, the recording device 302 may transition to the first buffering mode (e.g., the second buffering mode 208 in FIG. 2) based on the detected idle condition.

In some embodiments, the recording device 302 may determine that the recording device 302 is in an idle condition when the recording device 302 is supplied with power. For example, the recording device 302 may detect whether the recording device 302 is connected to a charging device (e.g., a battery, a power bank, etc.) or a power outlet via a power supply cable or a dock. If the recording device 302 is supplied with power, the recording device 302 may determine occurrence of an idle condition, and transition to the first buffering mode. In other examples, an idle condition comprising recording device 302 being coupled to an external power supply may cause recording device 302 to transition to the standby mode. In some embodiments, the transition to either such mode may decrease power consumption of the recording device 302. The decreased power consumption may, in turn, increase a charging speed of recording device 302.

As mentioned earlier, in some embodiments, the executable instructions for operating a system using multiple buffering modes 318 may further include executable instructions which, when executed by the one or more processors 304, further cause the recording device 302 to monitor one or more parameters to detect an idle condition and/or pre-event condition for the recording device 302. In some examples, the recording device 302 may transition to the first buffering mode (e.g., the second buffering mode 208 in FIG. 2) based on the detected idle condition.

In some examples, the recording device 302 may further include a timer 324. The timer 324 may be used to detect a parameter comprising a period of time. When a pre-event condition has not been detected while recording device 302 is operated in the second buffering mode for a predetermined time using the timer 324 since an entry to the second buffering mode, the recording device 302 may determine an idle condition or a deactivation condition and the recording device 302 may transition to the lower power consumption mode, such as the first buffering mode or the standby mode. In some examples, the pre-event condition indicative of an increased probability of an event may be met if the recording device 302 detects an interruption of an idle condition.

In some examples, the executable instructions for operating a system using multiple buffering modes 116 may include executable instructions that cause the one or more processors 304 to append at least a portion of the buffered video data to the recorded data. The buffered video data may include video data buffered while the recording device 302 is operated in a lower quality level buffering mode and/or a higher quality level buffering mode in embodiments according to various aspects of the present disclosure. In some embodiments, the executable instructions for operating a system using multiple buffering modes 116 may include executable instructions that cause the one or more processors 304 to generate a video file including the recorded video data and at least a portion of the buffered video data. The video file may be reproduced by an electronic device wirelessly or directly coupled to the recording device 302, read out wirelessly or directly from the recording device 302, or wirelessly or directly transmitted from the recording device 302 to another electronic device. Thus, a longer record of the event including the pre-event scene before the user's activation of the recording device 302 may be obtained by combining the video data buffered in the first buffering mode with the video data buffered in the second buffering mode or recorded video data.

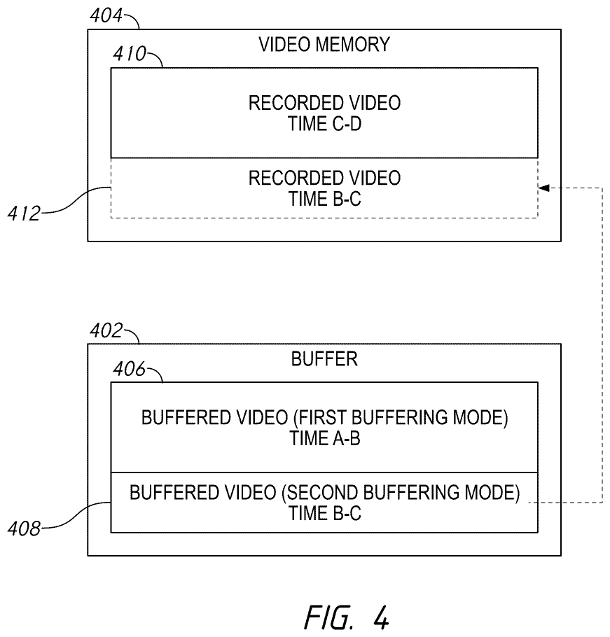

FIG. 4 is a block diagram of a buffer 402 and video memory 404 according to an embodiment of the present disclosure. In some embodiments, the buffer 402 and the video memory 404 may be the one or more buffers 108 and the video memory 110 in the recording device 100 of FIG. 1, respectively. The buffer 402 and the video memory 404 may include any of the features of the one or more buffers 108 and the video memory 110, and vice versa, respectively. Thus, detailed description of structures of the buffer 402 and the video memory 404 that have been previously described referring to the one or more buffers 108 and the video memory 110 is therefore not repeated herein for brevity.

In some examples, the buffer 402 may store video data, including buffered video data 406 and 408. The buffered video data 406 may be captured from time A to time B and stored by an apparatus including the buffer 402 in the first buffering mode, and the buffered video data 408 may be captured from time B to time C and stored by the apparatus in the second buffering mode. Thus, the buffered video data 408 may have a higher quality than the buffered video data 406. The video memory 404 may store video data stored by the apparatus in the recording mode, including recorded video data 410 including an event scene captured from time C to time D recorded in the higher quality. When the activation signal is received, the buffered video data 408 from time B to time C captured immediately before the recording mode may be transferred to the video memory 404 and appended to the recorded video data 410 as the recorded video data 412 from time B to time C recorded in the higher quality. Thus, a pre-event information regarding an event captured in the buffered video data 408 may be available as the recorded video data 412 for subsequent retrieval or transmission, along with the subsequently recorded video data 410. In some embodiments, at least a portion of the buffered video captured from time B-C may overwrite at least a portion of the buffered video data captured from time A-B in accordance with time and/or storage space limits selected for buffer 402. For example, when a time limit for buffering video data in buffer 402 is less than period of time between time B and time C, the buffered video data captured from time B-C may overwrite all of the buffered video data captured from time A-B in accordance with the time limit.

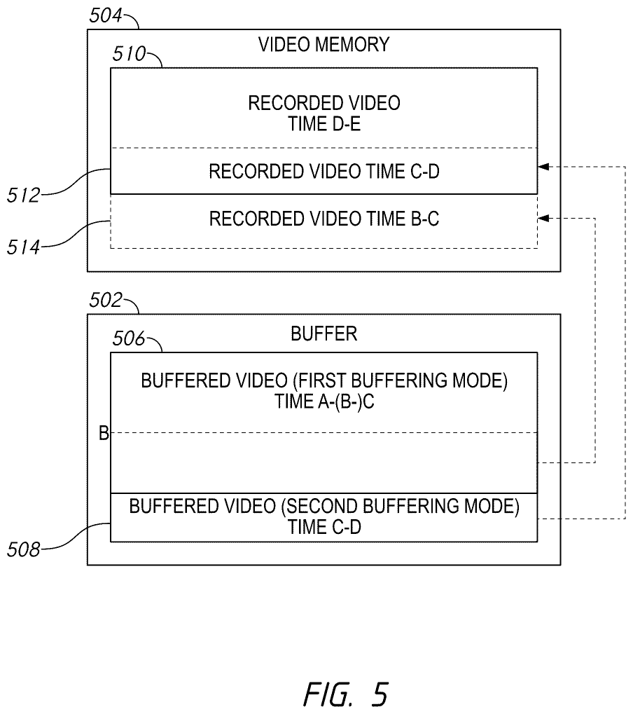

FIG. 5 is a block diagram of a buffer 502 and video memory 504 according to an embodiment of the present disclosure. The video memory 504 includes recorded video from time D-E 510 and may include recorded video from time C-D 512 and recorded video from time B-C 514. The buffer 502 includes buffered video buffered using a first buffering mode from time A B-C 506. The buffer 502 also includes buffered video buffered using a second buffering mode from time C-D 508.

The components shown in FIG. 5 are exemplary only, and additional, fewer, and/or different components may be used in other examples. For example, while the video memory 504 and the buffer 502 are depicted separately, in some examples, they may co-exist in a shared physical memory and/or be distributed across additional memory devices.

In some embodiments, the buffer 502 and the video memory 504 of FIG. 5 may be implemented by and/or used to implement the one or more buffers 108 and the video memory 110 of FIG. 1, respectively. The buffer 502 and the video memory 504 may include any of the features of the one or more buffers 108 and the video memory 110, and vice versa, respectively. Thus, detailed description of structures of the buffer 502 and the video memory 504 that have been previously described referring to the one or more buffers 108 and the video memory 110 is therefore not repeated herein for brevity.

In some examples, the buffer 502 may store video data, including buffered video data 506 and 508. The buffered video data 506 may be captured from time A to time C and stored by an apparatus including the buffer 502 in the first buffering mode. The buffered video data 508 may be captured from time C to time D and stored by the apparatus in the second buffering mode. The buffered video data 508 may have a higher quality than the buffered video data 506. The video memory 504 may store video data stored by the apparatus in the recording mode. For example, the video memory 504 may include recorded video data 510 including an event scene captured from time D to time E recorded in the higher quality. When the activation signal is received, the buffered video data 508 from time C to time D captured immediately before the recording mode may be transferred to the video memory 504 and appended to the recorded video data 510 as the recorded video data 512 from time C to time D recorded in the higher quality. In some examples, a longer pre-event video may be or designated, such as pre-event video associated with time B to time D. In such an example, at least a portion of the buffered video data 506 from time B to time C captured immediately before the buffered video data 508 may also be transferred to the video memory 504, along with the buffered video data 508 from time C to time D. In some examples, time B may be later than time A and earlier than time C. In some examples, the portion of the buffered video data 506 available for transfer may be determined in accordance with a limit to an amount of the buffered video data that may be temporarily stored before oldest video data of the buffered video data is automatically deleted. For example, when the activation signal is received, a second portion of the buffered video data 506 from time A to B may not be available for transfer to video memory 504. In some examples, the video quality of the portion of the buffered video data 506 from time B to time C may be changed prior to the transfer by video data conversion, such as upsampling or interpolation to increase a frame rate or upscaling to increase a resolution to match the higher quality of the recorded video data 510. Thus, the portion of the buffered video data 506 from time B to time C may be converted into video data 514 from time B to time C having the higher quality and appended to the video data 510 and 512 in the video memory 504. Thus, recorded video data 512 and 514 in which pre-event information was captured from time B to time D provided from the buffered video data 508 and at least a converted portion of the buffered video data 506 may be available for subsequent retrieval or transmission, along with the recorded video data 510.

The embodiments described above referring to FIG. 5 are merely examples. In some examples, conversion of video data buffered in the first buffering mode into video data having the higher quality may be performed any time before reproduction of the video data for review. For example, the conversion of video data may be performed after retrieval or transmission of the video segment before reproduction.

As described above, operations of a system including a video recording device in multiple buffering modes have been disclosed. The video recording device may buffer captured image data as video data having a plurality of qualities, including video data having a first quality and video data having a second quality. The system may be operated in a first buffering mode to buffer video data having a first quality. Responsive to a recording condition, the system may be operated to record video data having a second quality that is higher than the first quality. Responsive to a pre-event condition with an increased probability of the recording condition, the system may be operated in a second buffering mode to buffer video data having the second quality. At least a portion of the buffered video data may be appended to the recorded data. Thus, pre-event activities may be buffered and recorded in different video qualities depending on probabilities of occurrences of events. Buffering at least a portion of video data in a lower quality may reduce power consumption.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

Examples described herein may refer to various components as “coupled” or “connected” or signals as being “provided to” or “received from” certain components. It is to be understood that in some examples the components are directly coupled one to another, while in other examples the components are coupled with intervening components disposed between them. Similarly, signals or communications may be provided directly to and/or received directly from the recited components without intervening components, but also may be provided to and/or received from the certain components through intervening components.

The description of embodiments of the disclosure is not intended to be exhaustive or to limit the disclosure to the precise forms disclosed. While the specific embodiments of, and examples for, the disclosure are described herein for illustrative purposes, various modifications are possible within the scope of the disclosure.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

What is claimed is:

1. A method comprising:
operating a system in a first buffering mode to buffer video data having a first quality;
responsive to a first condition, operating the system in a second buffering mode to buffer video data having a second quality, wherein the second quality is higher than the first quality; and
responsive to a second condition, recording video data using the system.

2. The method of claim 1, wherein the recording video data includes recording the video data having the second quality.

3. The method of claim 1, wherein the first buffering mode consumes less power than the second buffering mode.

4. The method of claim 1, further comprising detecting, via a motion sensor of the system a decrease in speed of movement of the system; and detecting the first condition in accordance with the decrease in speed of movement of the system.

5. The method of claim 1, comprising determining the system is exiting a vehicle; and
detecting the first condition in accordance with determining the system is exiting the vehicle.

6. The method of claim 1, comprising determining a mode of operation of a nearby recording device; and
detecting the first condition in accordance with determining the mode of operation of the nearby recording device.

7. The method of claim 1, further comprising:
accessing communication with a response system coupled to the system;
detecting a response in the communication, the response provided by a user attached to the system; and
determining the first condition is met if the response is indicative of an acceptance of a predetermined task.

8. The method of claim 1, wherein the second condition is different from the first condition.

9. The method of claim 1, further comprising:
responsive to a third condition, stopping operating the system to buffer in the second buffering mode; and
transitioning from the second buffering mode to the first buffering mode.

10. The method of claim 9, wherein the third condition is met when the system is in a vehicle.

11. The method of claim 9, wherein the third condition is met when a remaining power in a battery is low.

12. The method of claim 9, further comprising determining, in accordance with motion information detected via a motion/position sensor of the system, an increase in speed of the system; and detecting the third condition in accordance with the increase in speed of the system.

13. The method of claim 1, further comprising:
operating an image sensor to provide video data in the first quality in the first buffering mode; and
operating the image sensor to provide video data in the second quality in the second buffering mode.

14. The method of claim 1, further comprising:
detecting the first condition in accordance with a first threshold; and
detecting the second condition in accordance with a second threshold, wherein the first threshold is different from the second threshold.

15. The method of claim 1, wherein operating the system in a first buffering mode includes:
detecting an idle condition; and
responsive to detecting the idle condition, decreasing a quality at which video data is subsequently buffered to operate system in the first buffering mode.

16. The method of claim 15, wherein detecting the idle condition includes one or more of detecting the system is located in a vehicle, detecting the system is proximate a user equipment, detecting the system is proximate a recording device separate from the system, detecting the system is moving at a same speed as a recording device proximate the system, detecting a pre-event mode of operation of each of one or more nearby recording devices, detecting an event mode of operation of each of one or more nearby recording devices, detecting a sound pressure level of an environment in which the system is positioned, detecting the system is coupled to an external power supply, and/or detecting the system is located at a predetermined position.

17. The method of claim 1, further comprising:
detecting the first condition; and
responsive to detecting the first condition, increasing a quality at which video data is subsequently buffered to operate system in the second buffering mode, wherein the first condition includes a pre-event condition.

18. The method of claim 17, wherein detecting the first condition includes one or more of detecting a decreased proximity to a vehicle, detecting a recording mode of operation of one more nearby recording devices, detecting a sound pressure level of an environment in which the system is located, detecting an increase in motion information associated with the system, detecting motion information above a predetermined threshold value, detecting a health information, and/or detecting a decrease in speed of the system.

19. An apparatus comprising:
a buffer configured to store buffered video data;
a video memory configured to store recorded video data;
a processor; and
a program memory encoded with executable instructions which, when executed by the processor, cause the apparatus to perform operations comprising:
buffering video data at a first quality in the buffer;
responsive to a first condition, modifying a quality at which the video data is subsequently buffered in the buffer; and
responsive to a second condition, recording the video data in the video memory, wherein modifying the quality includes increasing or decreasing the quality at which the video data is buffered in the buffer.

20. The apparatus of claim 19, wherein the recorded video data stored in the video memory has the second quality.

21. The apparatus of claim 19, wherein the executable instructions which, when executed by the processor, further cause the apparatus to determine the first condition.

22. The apparatus of claim 21, wherein the second condition is based on an action by a user.

23. The apparatus of claim 21, further comprising an image sensor configured to capture image data and provide the video data based on the image data.

24. The apparatus of claim 23, wherein the executable instructions which, when executed by the processor, further cause the apparatus to operate the image sensor to provide video data having the first quality, and further operate the image sensor to provide video data having the second quality responsive to either the first condition or the second condition.

25. The apparatus of claim 21, wherein the video data having the first quality has a first frame rate, and
wherein the video data having the second quality has a second frame rate higher than the first frame rate.

26. The apparatus of claim 21, wherein the video data having the first quality has a first resolution, and
wherein the video data having the second quality has a second resolution higher than the first resolution.

27. The apparatus of claim 19, wherein the first condition comprises an idle condition and the executable instructions which, when executed by the processor, further cause the apparatus to perform operations comprising:
detecting the idle condition; and
responsive to detecting the idle condition, decreasing the quality at which the video data is subsequently buffered to buffer the video data at the first quality in the buffer.

28. The apparatus of claim 27, wherein detecting the idle condition includes one or more of detecting the apparatus is located in a vehicle, detecting the apparatus is proximate a user device separate from the apparatus, detecting the apparatus is proximate a recording device separate from the apparatus, detecting the apparatus is moving at a same speed as a recording device proximate the apparatus, detecting a pre-event mode of operation of each of one or more nearby recording devices, detecting a sound pressure level of an environment in which the apparatus is positioned, detecting the apparatus is coupled to an external power supply, and/or detecting the apparatus is located at a predetermined position.

29. The apparatus of claim 27, wherein detecting the idle condition includes detecting the apparatus is located in a vehicle.

30. The apparatus of claim 27, wherein detecting the idle condition includes detecting the apparatus is proximate a user equipment separate from the apparatus.

31. The apparatus of claim 27, wherein detecting the idle condition includes detecting the apparatus is proximate a recording device separate from the apparatus.

32. The apparatus of claim 27, wherein detecting the idle condition includes detecting the apparatus is moving at a same speed as a recording device proximate the apparatus.

33. The apparatus of claim 27, wherein detecting the idle condition includes detecting a pre-event mode of operation of each of one or more nearby recording devices.

34. The apparatus of claim 27, wherein detecting the idle condition includes detecting a sound pressure level of an environment in which the apparatus is positioned.

35. The apparatus of claim 27, wherein detecting the idle condition includes detecting the apparatus is coupled to an external power supply.

36. The apparatus of claim 27, wherein detecting the idle condition includes detecting the apparatus is located at a predetermined position.

37. The apparatus of claim 27, wherein the executable instructions which, when executed by the processor, further cause the apparatus to perform operations comprising:
detecting a pre-event condition different from the idle condition and the recording condition; and
responsive to detecting the pre-event condition, increasing the quality at which the video data is subsequently buffered to buffer the video data at the second quality in the buffer.

38. The apparatus of claim 37, wherein the idle condition is detected prior to the pre-event condition.

39. The apparatus of claim 38, wherein the pre-event condition is detected prior to the second condition.

40. The apparatus of claim 37, wherein the idle condition is detected after the pre-event condition is detected.

41. The apparatus of claim 40, wherein the idle condition is detected before the second condition is detected.

42. The apparatus of claim 19, wherein the first condition comprises a pre-event condition and the executable instructions which, when executed by the processor, further cause the apparatus to perform operations comprising:
detecting the pre-event condition; and
responsive to detecting the pre-event condition, increasing a quality at which video data is subsequently buffered to buffer the video data having the second quality, wherein the first condition includes a pre-event condition.

43. The apparatus of claim 42, wherein detecting the pre-event condition includes one or more of detecting a decreased proximity to a vehicle, detecting a recording mode of operation of one more nearby recording devices, detecting a sound pressure level of an environment in which the apparatus is located, detecting an increase in motion information associated with the apparatus, detecting motion information above a predetermined threshold value, detecting a health information, and/or detecting a decrease in speed of the apparatus.

44. The apparatus of claim 42, wherein detecting the pre-event condition includes detecting a decreased proximity to a vehicle.

45. The apparatus of claim 42, wherein detecting the pre-event condition includes detecting a recording mode of operation of one more nearby recording devices.

46. The apparatus of claim 42, wherein detecting the pre-event condition includes detecting a sound pressure level of an environment in which the apparatus is located.

47. The apparatus of claim 42, wherein detecting the pre-event condition includes detecting an increase in motion information associated with the apparatus.

48. The apparatus of claim 42, wherein detecting the pre-event condition includes detecting motion information above a predetermined threshold value.

49. The apparatus of claim 42, wherein detecting the pre-event condition includes detecting a health information.

50. The apparatus of claim 42, wherein detecting the pre-event condition includes detecting a decrease in speed of the apparatus.

51. A method performed by a recording device comprising:
capturing video data;
buffering the video data at a first quality;
responsive to a first condition, modifying a quality at which the video data is buffered; and
responsive to a second condition, recording the video data, wherein modifying the quality includes increasing or decreasing the quality at which the video data is buffered.

52. An apparatus comprising:
a buffer configured to store buffered video data;
a video memory configured to store recorded video data;
a processor; and
a program memory encoded with executable instructions which, when executed by the processor, cause the apparatus to:
buffer video data having a first quality in the buffer;
responsive to a first condition, buffer video data having a second quality in the buffer,
wherein the second quality is higher than the first quality; and
responsive to a second condition, record video data in the video memory.
